(19) United States
(12) Patent Application Publication
(10) Pub. No.: US 2015/0050592 A1
(43) Pub. Date: Feb. 19, 2015

(54) TONER FOR ELECTROSTATIC CHARGE IMAGE DEVELOPMENT, METHOD OF MANUFACTURING THE SAME, AND IMAGE FORMING METHOD

(71) Applicant: Konica Minolta, Inc., Tokyo (JP)

(72) Inventors: Junya Ueda, Tokyo (JP); Hiroyuki Yasukawa, Tokyo (JP); Asao Matsushima, Tokyo (JP); Kimihiko Ookubo, Tokyo (JP)

(21) Appl. No.: 14/338,688

(22) Filed: Jul. 23, 2014

(30) Foreign Application Priority Data
Aug. 9, 2013 (JP) 2013-166154

(51) Int. Cl. G03G 9/09; G03G 9/08

(52) U.S. Cl. CPC G03G 9/0906; G03G 9/0825; G03G 9/0802
USPC 430/108.21; 430/105; 430/137.1; 430/440; 430/108.3

(57) ABSTRACT

The present invention relates to toner for electrostatic charge image development including a resin, a metal-containing compound, and a colorant compound precursor to be converted to a colorant compound through a reaction with the metal-containing compound by heat applied at heat fixing. According to the present invention, it is possible to provide toner for electrostatic charge image development which is excellent in fluidity and storage stability and a method of manufacturing the same.

### CROSS-REFERENCE TO RELATED APPLICATION

This application is based on Japanese Patent Application No. 2013-166154 filed on Aug. 9, 2013, the contents of which are incorporated herein by reference.

### BACKGROUND

1. Technical Field

The present invention relates to toner for electrostatic charge image used in the electrophotographic image formation, a method of manufacturing the same, and an image forming method.

2. Description of Related Arts

In the electrophotographic image forming method, printed matters are generally produced through the following processes. First, a photoreceptor is irradiated with the exposure light to form an electrostatic latent image thereon, and the latent image is developed by supplying toner to the photoreceptor having the electrostatic latent image formed thereon so as to form a toner image. Next, the toner image on the photoreceptor is transferred to an image support body such as paper, and the transferred toner image is heated and melted to be fixed to the image support body, thereby producing a printed matter. Meanwhile, the toner remaining on the photoreceptor to which the toner image is transferred is removed by a cleaning device, and the photoreceptor from which the residual toner is removed is charged and thus prepared for the next image formation.

In the image forming method described above, a full-color image can be formed by developing the electrostatic latent image with toner of various colors. In order to form a full-color image, electrostatic latent images of various colors corresponding to the respective image patterns separated into various colors are formed on the photoreceptor, and these electrostatic latent images are developed with toner of the corresponding colors. As a color toner to form such a color image, a yellow toner, a magenta toner, a cyan toner, and the like containing a binder resin including a thermoplastic resin and various kinds of colorants are used.

In the full-color image formation performed by superimposing the toner images formed by a single color toner as described above, the toner used is desired to be transparent. This is because it is desirable that the image of the undermost layer among the plural toner images is not hidden by the layer positioned above the undermost layer but the hue of the toner constituting the toner image of the undermost layer can be visually recognized when plural toner images are superimposed in the full-color image formation.

Hitherto, organic pigments and oil-soluble dyes well-known in the related art have been used as the colorant constituting the toner for electrostatic charge image development. Organic pigments generally exhibit excellent heat resistance or light resistance compared with oil-soluble dyes. However, organic pigments exhibits high hiding power since the organic pigments are present in the toner in a state of being dispersed as particles and thus the transparency of the toner deteriorates, and also the transparency deteriorates due to the poor dispersibility of pigment. In addition, there is a problem that the color saturation deteriorates when organic pigments are used. Moreover, there is a problem that favorable color reproducibility is hardly obtained in the printed matter formed by a toner using organic pigments.

As described above, the toner used in the formation of a full-color image is desired to exhibit transparency in the fixed state and provide a printed matter with excellent color reproducibility as well. In addition, a colorant having high dispersibility and tinting strength has been desired to obtain favorable color reproducibility.

To cope with such a request, JP 2009-282351 A discloses a method of manufacturing a toner including a step in which a mixture including a resin and a colorant compound precursor is obtained and the mixture and a metal-containing compound is mixed and heated to produce a colorant compound by the reaction thereof. In addition, JP 2009-282351 A also discloses toner containing a colorant compound obtained by the reaction of a colorant compound precursor with a metal-containing compound during the manufacture of the toner.

### SUMMARY

However, the toner for electrostatic charge image development containing a colorant compound obtained through the above step is not necessarily favorable in the fluidity and storage stability of toner, and thus a technique capable of improving the fluidity and storage stability of toner is desired. In addition, it is desired a technique by which the occurrence of density unevenness of printed matter caused by the use of toner having low fluidity at the time of image formation can be suppressed.

Hence, the present invention has been made in view of the circumstances described above, and a purpose thereof is to provide toner for electrostatic charge image development which is excellent in fluidity and storage stability and a method of manufacturing the same. In addition, another purpose of the present invention is to provide an image forming method that can suppress the occurrence of image unevenness.

The inventors have conducted intensive investigations in order to solve the above problem, and as a result, have found out that the above problem can be solved by toner for electrostatic charge image development containing a metal-containing compound and a colorant compound precursor in an unreacted state, thereby completing the present invention.

In other words, the above purpose of the present invention is achieved by the following constitution.

Toner for electrostatic charge image development containing a resin, a metal-containing compound, and a colorant compound precursor to be converted to a colorant compound through a reaction with the metal-containing compound by heat applied at heat fixing.

### BRIEF DESCRIPTION OF DRAWINGS

FIG. 1 is a schematic diagram of an image forming apparatus using the toner for electrostatic charge image development of the present invention.

### DETAILED DESCRIPTION

A first embodiment of the present invention provides toner for electrostatic charge image development (hereinafter, simply referred to as the “toner” in some cases) containing a resin, a metal-containing compound, and a colorant compound precursor to be converted to a colorant compound through a reaction with the metal-containing compound by heat applied at heat fixing. According to the present embodiment, toner for electrostatic charge image development which is excellent in fluidity and storage stability is provided.

The present invention is characterized in that toner contains a resin, a metal-containing compound, and a colorant compound precursor, and the metal-containing compound and the colorant compound precursor are contained in the toner in an unreacted state. A colorant compound can be produced through the reaction of the unreacted metal-containing compound and colorant compound precursor by heat applied when the toner image formed by the toner is heat fixed. Meanwhile, the fact that the metal-containing compound and the colorant compound precursor contained in the toner are in an unreacted state can be confirmed by the analysis of the spectral absorption spectrum for the toner. More specifically, the fact that the metal-containing compound and the colorant compound precursor are contained in the toner in an unreacted state can be confirmed by measuring the spectral absorption spectrum of each of the toner in which the metal-containing compound and the colorant compound precursor are contained in a reacted state and the toner of the present invention, and observing the difference between the spectra obtained. In addition, the fact that these substances are in an unreacted state can also be visually confirmed from the fact that the toner of the present invention does not exhibit the color tone as toner.

As described above, the inventors have found out that the fluidity and storage stability of toner can be improved by taking a form in which a colorant compound precursor to produce a colorant compound through the reaction with a metal-containing compound is present in the toner in a state of being unreacted with the metal-containing compound, thereby achieving the present invention.

The mechanism of exerting the function and effect according to the constitution of the present invention described above is presumed as follows.

The toner disclosed in JP 2009-282351 A is manufactured through the step of producing a colorant compound by heating and reacting a colorant compound precursor and a metal-containing compound in a resin. Hence, according to the technique disclosed in JP 2009-282351 A, it is possible to react a colorant compound precursor with a metal-containing compound which have relatively lower molecular weights in a wide region from the surface to the inside of the resin. As a result, the colorant compound is more stably present in the toner particles compared with the case of using a compound having a relatively higher molecular weights such as an organic pigment as a colorant, and thus the toner according to the manufacturing method disclosed in JP 2009-282351 A can exhibit a favorable color tone, moreover the stability of image density becomes favorable.

However, the inventors have found out that the toner manufactured by the manufacturing method disclosed in JP 2009-282351 A does not necessarily exhibits sufficient fluidity and storage stability. In addition, it is inferred that such deterioration in fluidity and storage stability is attributed to the thermal reaction of the colorant compound precursor with the metal-containing compound. In more detail, according to the method of manufacturing the toner disclosed in JP 2009-282351 A, a colorant compound is produced by heating and reacting a colorant compound precursor with a metal-containing compound in a resin during manufacturing toner base particles. However, chelation takes place by heating in order to produce the colorant compound to be contained in the toner, and thus the resin containing the colorant compound is plasticized in some cases. As such, when a metal-containing compound and a colorant compound precursor are heated in the process of manufacturing toner, a colorant compound can be produced, but a resin containing the colorant compound is plasticized and thus viscosity thereof increases. As a result, it is believed that the fluidity and storage stability of toner to be obtained may deteriorate.

Moreover, the unevenness of image density may occur when an image is formed using toner exhibiting unfavorable fluidity as described above since the toner supplied into the developing device is unevenly charged.

In contrast to this, the toner of the present invention contains a metal-containing compound and a colorant compound precursor to be converted to a colorant compound through the reaction with the metal-containing compound by heat applied at heat fixing. In other words, the toner of the present invention contains a metal-containing compound and a colorant compound precursor dispersed in a resin (resin particles) in an unreacted state. Hence, each of the metal-containing compound and the colorant compound precursor is present in the toner in a solid state before heat fixing is performed, that is, in the storage state and these substances are not converted to the colorant compound (that is, reaction product), and thus the plasticization of the resin constituting the toner is suppressed. As a result, the fluidity and storage stability of the toner can be favorably maintained. Meanwhile, the present invention is not intended to be limited in any way by the mechanism described above.

Hereinafter, an embodiment according to the toner for electrostatic charge image development of the present invention will be described. Meanwhile, the same reference numerals are given to the same elements, and overlapping description will not be presented in the description of the drawings. Dimensional ratios of the drawings are exaggerated for convenience of description and may be different from the actual ratios.

In addition, as used herein, the “from X to Y” indicating the range means “X or more and Y or less”, and “weight” and “mass”, “% by weight” and “% by mass”, and “parts by weight” and “parts by mass” are treated as synonyms. In addition, unless otherwise stated, the operations and the measurements of physical properties are conducted under the condition of room temperature (20° C.)/relative humidity of 40 to 50%.

[Toner for Electrostatic Charge Image Development]

The toner for electrostatic charge image development of the present invention essentially contains a resin, a colorant compound precursor, and a metal-containing compound. Hereinafter, each constituent material will be described.

(Resin)

In the toner of the present invention, the colorant compound precursor and the metal-containing compound which are converted to a colorant compound are dispersed in the resin (binder resin) or on the surface of the resin (binder resin). The polymer constituting the resin usable in the present invention contains a polymer obtained by polymerizing at least one kind of polymerizable monomer as a constituent component. A well-known polymerizable monomer can be used as the polymerizable monomer constituting the resin.

As the resin, a vinyl-based resin, a polyester-based resin, a styrene-acrylic-modified polyester resin and the like are preferable, and a vinyl-based resin which is a polymer produced from one vinyl-based monomer or by combining plural kinds of vinyl-based monomers is preferable among them.

In the present invention, the weight average molecular weight Mw of the resin is preferably 10,000 or more and 100,000 or less and more preferably 15,000 or more and 80,000 or less. Meanwhile, the molecular weight of the resin used in the present invention can be controlled by a well-known method, for example, a resin having a weight average molecular weight within the above range can be produced by controlling the addition amount of a polymerization initiator or a chain transfer agent when the resin is formed. Meanwhile, the weight average molecular weight Mw of resin in the present specification adopts the value in terms of polystyrene measured by gel permeation chromatography (GPC) using tetrahydrofuran (THF) as a column solvent.

In addition, the glass transition temperature (Tg) of the resin is not particularly limited, but is preferably from 40 to 70° C. and more preferably from 50 to 65° C. As it will be described in detail below, the toner of the present invention may be kept at a temperature equal to or higher than the glass transition temperature of the polymer constituting the resin particles when the resin particles are aggregated in the manufacturing step thereof. Hence, it is preferable to use a resin having a glass transition temperature in the above range since the colorant compound precursor or the metal-containing compound is easily preserved without reacting while the aggregation of the resin particles constituting the toner effectively occurs. In addition, it can also obtain an effect that the reaction of the colorant compound precursor with the metal-containing compound can sufficiently proceed at heat fixing of the toner when a resin having a glass transition temperature in the above range is used.

Hereinafter, specific examples of the resin constituting the toner of the present invention will be described in detail.

Vinyl-Based Resin

A vinyl-based resin is a polymer obtained by polymerizing a radical polymerizable monomer, and can use the following polymerizable monomers.

Examples of the polymerizable monomer constituting the vinyl-based resin include a styrene or a styrene derivative such as styrene, o-methylstyrene, m-methylstyrene, p-methylstyrene, α-methylstyrene, p-chlorostyrene, 3,4-dichlorostyrene, p-phenylatyrene, p-ethylstyrene, 2,4-dimethylstyrene, p-tert-butylstyrene, p-n-hexylstyrene, p-n-octylatyrene, p-n-nonylstyrene, p-n-decylstyrene, and p-n-dodecylstyrene, and a methacrylic ester derivative such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate, an acrylic ester derivative such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate, an olefin such as ethylene, propylene, and isobutylene, a vinyl halide such as vinyl chloride, vinylidene chloride, vinyl bromide, vinyl fluoride, and vinylidene fluoride, a vinyl ester such as vinyl propionate, vinyl acetate, and vinyl benzoate, a vinyl ether such as vinyl methyl ether and vinyl ethyl ether, a vinyl ketone such as vinyl methyl ketone, vinyl ethyl ketone, and vinyl hexyl ketone, a N-vinyl compound such as N-vinyl carbazole, a vinyl compound such as vinyl naphthalene or vinyl pyridine, and a derivative of acrylic acid or methacrylic acid such as acrylonitrile, methacrylonitrile, and acrylamide. The polymerizable monomers above can be used singly or in combination. A styrene-acrylic copolymer is preferable as a resin obtained by combining the polymerizable monomers above.

In addition, it is even more preferable to use a polymerizable monomer having an ionic leaving group in combination as a polymerizable monomer constituting the resin. Examples of the polymerizable monomer having an ionic dissociable group include those having a substituent such as a carboxyl group, a sulfonic acid group, a phosphoric acid group, as a constituent group of a monomer, and specific examples thereof include acrylic acid, methacrylic acid, maleic acid, and itaconic acid.

Moreover, the resin constituting the toner may also be a resin having a crosslinked structure obtained using a multifunctional vinyl such as divinylbenzene, ethylene glycol dimethacrylate, ethylene glycol diacrylate, diethylene glycol dimethacrylate, and diethylene glycol diacrylate.

The resin constituting the toner is produced by polymerizing the polymerizable monomer described above, and the radical polymerization initiator usable in the present invention is as follows. In specific, an oil-soluble polymerization initiator can be used in a suspension polymerization method, and examples thereof include an azo or diazo polymerization initiator such as 2,2′-azobis-(2,4-dimethylvaleronitrile), 2,2′-azobisisobutyronitrile, and 1,1′-azobis(cyclohexane-1-carbonitrile), and a peroxide polymerization initiator such as benzoyl peroxide, methyl ethyl ketone peroxide, diisopropyl peroxycarbonate, cumene hydroperoxide, and t-butyl hydroperoxide or a macroinitiator having a peroxide in a side chain.

It is required to perform the oil droplet dispersion in an aqueous medium using a surfactant in order to perform the polymerization using a radical polymerizable monomer. The surfactant usable in this case is not particularly limited, but the following ionic surfactants can be exemplified as a suitable surfactant.

Examples of the ionic surfactant include a salt of sulfonic acid (sodium dodecylbenzene sulfonate, sodium alkyl aryl polyether sulfonate, or the like), a salt of a sulfuric ester (sodium dodecyl sulfate, sodium tetradecyl sulfate, sodium pentadecyl sulfate, sodium octyl sulfate, or the like) and a salt of a fatty acid (sodium oleate, sodium laurate, sodium caprate, sodium caprylate, sodium caproate, potassium stearate, calcium oleate, or the like).

In addition, a nonionic surfactant can also be used. Specific examples thereof include polyethylene oxide, polypropylene oxide, a combination of polypropylene oxide and polyethylene oxide, an ester of polyethylene glycol and a higher fatty acid, alkylphenol polyethylene oxide, and an ester of a higher fatty acid and polypropylene oxide.

In addition, a water-soluble radical polymerization initiator can be used when an emulsion polymerization method is used. Examples of the water-soluble polymerization initiator may include a salt of persulfuric acid such as potassium persulfate and ammonium persulfate, azobisaminodipropane acetic acid salt, and hydrogen peroxide.

In addition, a generally used chain transfer agent can be used for the purpose of adjusting the molecular weight of the resin. The chain transfer agent is not particularly limited, and examples thereof may include a mercaptan such as n-octyl mercaptan and dodecyl mercaptan, and n-octyl 3-mercaptopropionate.

In addition, a dispersion stabilizer can also be used in order to preserve the polymerizable monomer or the like in the reaction system in an appropriately dispersed state. Examples of the dispersion stabilizer may include tricalcium phosphate, magnesium phosphate, zinc phosphate, aluminum phosphate, calcium carbonate, magnesium carbonate, calcium hydroxide, magnesium hydroxide, and aluminum hydroxide or the like. Moreover, those generally used as a surfactant, such as polyvinyl alcohol, gelatin, methyl cellulose, and sodium higher alcohol sulfate, can be used as the dispersion stabilizer.

Polyester-Based Resin

A polyester-based resin is formed by conducting the polycondensation reaction of a well-known polycarboxylic acid and a well-known polyhydric alcohol in the presence of a catalyst. The polyester-based resin can also use derivatives of the polycarboxylic acid and the polyhydric alcohol as the starting materials. Examples of the derivative of the polycarboxylic acid include an alkyl ester of a polycarboxylic acid, or an acid anhydride, and an acid chloride, or the like. Examples of the derivative of polyhydric alcohol include an ester compound of a polyhydric alcohol and a hydroxy carboxylic acid, or the like.

Hereinafter, specific examples of the polycarboxylic acid and the polyhydric alcohol usable in the formation of the polyester-based resin will be described. First, examples of the polycarboxylic acid include a well-known dicarboxylic acid referred to as an aliphatic dicarboxylic acid or an aromatic dicarboxylic acid, or a tri- or higher valent carboxylic acid. Specific examples of the dicarboxylic acid include oxalic acid, succinic acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, malonic acid, pimelic acid, tartaric acid, phthalic acid, isophthalic acid, terephthalic acid, tetrachlorophthalic acid, chlorophthalic acid, nitrophthalic acid, hexahydroterephthalic acid, p-carboxyphenylacetic acid, p-phenylenediacetic acid, m-phenylenediglycolic acid, p-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and dodecenylsuccinic acid. In addition, specific examples of the tri- or higher valent carboxylic acid include trimellitic acid, pyromellitic acid, naphthalenetricarboxylic acid, naphthalenetetracarboxylic acid, pyrenetricarboxylic acid, and pyrenetetracarboxylic acid, or the like. These polycarboxylic acids can be used singly or in combination of two or more kinds thereof.

Next, specific examples of the polyhydric alcohol will be described. Examples of the polyhydric alcohol usable in the formation of the polyester-based resin include a well-known dihydric alcohol or a well-known tri- or higher valent alcohol. Specific examples of the dihydric alcohol include ethylene glycol, propylene glycol, butanediol, diethylene glycol, hexanediol, cyclohexanediol, octanediol, decanediol, dodecanediol, an ethyleneoxide adduct of bisphenol A, and a propyleneoxide adduct of bisphenol A, or the like. In addition, specific examples of the tri- or higher valent alcohol include glycerol, pentaerythritol, hexamethylol melamine, hexaethylol melamine, and tetramethylol benzoguanamine, or the like. These polyhydric alcohols may be used singly or in combination of two or more kinds thereof.

As the method of forming the polyester-based resin, a method well-known in the related art may be adopted in which a polyester-based resin is formed through the polycondensation reaction of a polycarboxylic acid and a polyhydric alcohol in the presence of a catalyst. In addition, a well-known catalyst can be used as the catalyst.

Styrene-Acrylic-Modified Polyester Resin

The “styrene-acrylic-modified polyester resin” is a resin constituted by a polyester molecule having a structure in which a styrene-acrylic copolymer molecular chain (also referred to as the “styrene-acrylic copolymer segment”) is molecular bonded to a polyester molecular chain (also referred to as the “polyester segment”). In other words, the styrene-acrylic-modified polyester resin is a resin having a copolymer structure in which a styrene-acrylic copolymer segment is covalently bonded to a polyester segment.

The polyester segment constituting the styrene-acrylic-modified polyester resin is produced by the same material and method as those of the polyester-based resin described above, and thus the detailed description thereof will not be presented here.

The compounds forming the styrene-acrylic copolymer segment will be described. The styrene-acrylic copolymer segment constituting the styrene-acrylic-modified polyester resin used in the present invention is formed by the addition polymerization of at least a styrene monomer and a (meth)acrylic ester monomer. The styrene monomer referred here includes a styrene of a structure having a well-known side chain or functional group in the styrene structure in addition to a styrene represented by a structural formula of CH₂═CH—C₆H₅. In addition, the (meth)acrylic ester monomer referred here includes an ester compound having a well-known side chain or functional group in a structure such as an acrylic ester derivative or a methacrylic ester derivative in addition to an acrylic ester compound represented by CH₂═CHCOOR (R represents an alkyl group) or a methacrylic ester compound.

Hereinafter, the styrene monomer and the (meth)acrylic ester monomer capable of forming the styrene-acrylic copolymer segment will be briefly described, but the substance usable in the formation of the styrene-acrylic copolymer segment used in the present invention is not limited to the following substances.

First, specific examples of the styrene monomer include the styrenes described in the section of the vinyl-based resin above, and thus the detailed description thereof will not be presented here. The styrene monomers can be used singly or in combination of two or more kinds thereof.

In addition, specific examples of the (meth)acrylic ester monomer include the acrylic esters and the methacrylic esters described in the sect ion of the vinyl-based resin above, and thus the detailed description thereof will not be presented here.

These acrylic ester monomers and methacrylic ester monomers can be used singly or in combination of two or more kinds thereof. In other words, it is possible to form a copolymer using a styrene monomer and two or more kinds of acrylic ester monomers, to form a copolymer using a styrene monomer and two or more kinds of methacrylic ester monomers, or to form a copolymer concurrently using a styrene monomer, an acrylic ester monomer, and a methacrylic ester monomer.

The method of forming the styrene-acrylic copolymer segment is not particularly limited, and a method to polymerize monomers using a well-known oil-soluble or water-soluble polymerization initiator are exemplified. Specific examples of the oil-soluble polymerization initiator include the azo or diazo polymerization initiator or the peroxide polymerization initiator described below.

In addition, a compound to perform molecular bond in which the polyester segment and the styrene-acrylic copolymer segment are binded may be used. This compound preferably has a functional group subjectable to a condensation reaction with a carboxyl group (—COOH), a hydroxyl group (—OH), or the like remaining in the polyester segment, and an unsaturated structure such as a carbon-carbon double bond subjectable to an addition reaction with the styrene-acrylic copolymer segment. Specific examples of such a compound include a vinyl compound having a carboxyl group such as acrylic acid, methacrylic acid, fumaric acid, and maleic acid, or a carboxylic anhydride such as anhydrous maleic acid.

(Colorant Compound Precursor)

The colorant compound precursor contained in the toner of the present invention is a compound that reacts with a metal-containing compound to be described in detail below by heat applied at heat fixing. The colorant compound precursor is dispersed in the resin particles (or the surface of the resin particles), and present in a state of not reacting with the metal-containing compound at room temperature (during storage), but provides a colorant compound through a reaction with the metal-containing compound by heat applied at heat fixing. At this time, the temperature at which the colorant compound precursor provides the colorant compound through a reaction with the metal-containing compound is a general heat fixing temperature, and preferably from 120 to 200° C. and more preferably from 140 to 180° C. The colorant compound precursor used is preferably solid at room temperature in order to improve the fluidity and storage stability of the toner to be obtained.

More specifically, the colorant compound precursor is preferably a compound represented by General formula (1) or (2).

Hereinafter, the compound represented by General formula (1) will be described. Meanwhile, as used herein, the term “hetero” means to contain one or more heteroatoms selected from N, O, S or P unless otherwise stated. In addition, the term “heterocycle” is a generic term for a cyclic structure containing one or more heteroatoms selected from N, O, S or P.

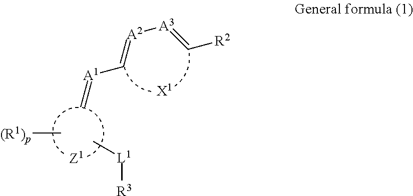

In General formula (1) above, R¹ each independently represent a hydrogen atom, a halogen atom or a monovalent organic group, R² represents a —NR⁴R⁵ group (R⁴ and R⁵ each independently represent a hydrogen atom, a halogen atom or a monovalent organic group) or a —OR⁶ group (R⁶ represents a hydrogen atom, a halogen atom or a monovalent organic group), R³ represents a hydroxyl group, an alkoxy group, an aryloxy group, an amino group, an amide group, an alkylsulfonylamino group or an arylsulfonyl amino group, A¹ to A³ each independently represent a —CR⁷═ group (R⁷ each independently represent a hydrogen atom, a halogen atom or a monovalent organic group), or a —N═ group, X¹ represents an atomic group necessary to form a 5- or 6-membered aromatic or heterocyclic ring, and Z¹ represents an atomic group necessary to form a 5- or 6-membered heterocyclic ring containing at least one nitrogen atom and this atomic group is optionally unsubstituted or optionally has a substituent, or optionally form a condensed ring with the substituent. L¹ represents a linking group having 1 or 2 carbon atoms or a part of a ring structure, and is optionally bonded to R³ to form a 5- or 6-membered ring structure. p represents an integer of 0 to 3.

In General formula (1) above, each of R¹ may be an independent group in a case in which p is 2 or 3.

Examples of the halogen atom representing the group R¹ include a fluorine atom, a chlorine atom, and a bromine atom.

In addition, examples of the monovalent organic group representing the group R¹ include an alkyl group having from 1 to 20 carbon atoms (for example, a methyl group, an ethyl group, a propyl group, an isopropyl group, a tert-butyl group, a pentyl group, a hexyl group, an octyl group, a dodecyl group, a tridecyl group, a tetradecyl group, a pentadecyl group, or the like), a cycloalkyl group having from 3 to 20 carbon atoms (for example, a cyclopentyl group, a cyclohexyl group, or the like), an alkenyl group having from 2 to 20 carbon atoms (a vinyl group and an allyl group), an alkynyl group having from 2 to 20 carbon atoms (for example, an ethynyl group, a propargyl group, or the like), an aryl group having from 6 to 20 carbon atoms (for example, a phenyl group, a naphthyl group, or the like), a heteroaryl group having from 2 to 20 carbon atoms (for example, a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazolyl group, a phthalazyl group, or the like), a heterocyclic group having from 2 to 20 carbon atoms (for example, a pyrrolysyl group, an imidazolidyl group, a morphoryl group, an oxazolidyl group, or the like), an alkoxy group having from 1 to 20 carbon atoms (for example, a methoxy group, an ethoxy group, a propyloxy group, a pentyloxy group, a hexyloxy group, an octyloxy group, a dodecyloxy group, or the like), a cycloalkoxy group having from 3 to 20 carbon atoms (for example, a cyclopentyloxy group, a cyclohexyloxy group, or the like), an aryloxy group having from 6 to 20 carbon atoms (for example, a phenoxy group, a naphthyloxy group, or the like), an alkylthio group having from 1 to 20 carbon atoms (for example, a methylthio group, an ethylthio group, a propylthio group, a pentylthio group, a hexylthio group an octylthio group, a dodecylthio group, or the like), a cycloalkylthio group having from 3 to 20 carbon atoms (for example, a cyclopentylthio group, a cyclohexylthio group, or the like), an arylthio group having from 6 to 20 carbon atoms (for example, a phenylthio group, a naphthylthio group, or the like), an alkoxycarbonyl group having from 2 to 20 carbon atoms (for example, a methyloxycarbonyl group, an ethyloxycarbonyl group, a butyloxycarbonyl group, an octyloxycarbonyl group, a dodecyloxycarbonyl group, or the like), an aryloxycarbonyl group having from 7 to 20 carbon atoms (for example, a phenyloxycarbonyl group, a naphthyloxycarbonyl group, or the like), a sulfamoyl group having from 1 to 20 carbon atoms (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, a 2-pyridylaminosulfonyl group, or the like), an acyl group having from 2 to 20 carbon atoms (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecycarbonyl group, a phenylcarbonyl group, a naphthylcarbonyl group, a pyridylcarbonyl group, or the like), an acyloxy group having from 2 to 20 carbon atoms (for example, an acetyloxy group, an ethylcarbonyloxy group, a butylcarbonyloxy group, an octylcarbonyloxy group, a dodecylcarbonyloxy group, a phenyl carbonyloxy group, or the like), an amide group having from 1 to 20 carbon atoms (for example, a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a trifluoromethylcarbonylamino group, a phenylcarbonylamino group, a naphthylcarbonylamino group, or the like), a carbamoyl group having from 1 to 20 carbon atoms (for example, an aminocarbonyl group, a methylaminocarbonyl group, a dimethylaminocarbonyl group, a propylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, a 2-pyridylaminocarbonyl group, or the like), an ureido group having from 1 to 20 carbon atoms (for example, a methylureido group, an ethylureido group, a pentylureido group, a cyclohexylureido group, an octylureido group, a dodecylureido group, a phenylureido group, a naphthylureido group, a 2-pyridylaminoureido group, or the like), an alkylsulfinyl group having from 1 to 20 carbon atoms (for example, a methylsulfinyl group, an ethylsulfinyl group, a butylsulfinyl group, a cyclohexylsulfinyl group, a 2-methylhexylsulfinyl group, a dodecylsulfinyl group, a phenylsulfinyl group, a 2-pyridylsulfinyl group, or the like), an alkylsulfonyl group having from 1 to 20 carbon atoms (for example, a methylsulfonyl group, an ethylsulfonyl group, a butylsulfonyl group, a cyclohexylsulfonyl group, a 2-ethylhexylsulfonyl group, a dodecylsulfonyl group, or the like), an arylsulfonyl group having from 6 to 20 carbon atoms (for example, a phenylsulfonyl group, a naphthylsulfonyl group, a 2-pyridylsulfonyl group, or the like), an alkylamino group having from 1 to 20 carbon atoms (for example, an ethylamino group, a dimethylamino group, a butylamino group, a cyclopentylamino group, a 2-ethylhexylamino group, a dodecylamino group, an anilino group, a naphthylamino group, a 2-pyridylamino group, or the like), an amino group, a cyano group, and a nitro group, which are substituted or unsubstituted.

Among the above, an alkyl group, a heteroaryl group, an alkoxycarbonyl group, a sulfamoyl group, an ureido group, and a cyano group are preferable.

In addition, in General formula (1), R² represents a —NR⁴R⁵ group (R⁴ and R⁵ each independently represent a hydrogen atom, a halogen atom or a monovalent organic group) or a —OR⁶ group (R⁶ represents a hydrogen atom, a halogen atom or a monovalent organic group).

This group R² is preferably the —NR⁴R⁵ group from the viewpoint of the molar extinction coefficient ε, and the —OR⁶ group from the viewpoint of wavelength adjustment.

Examples of the halogen atom representing R⁴ and R⁵ in the —NR⁴R⁵ group and R⁶ in the —OR⁶ group according to the group R² include a fluorine atom, a chlorine atom, and a bromine atom.

Examples of the monovalent organic group representing R⁴ and R⁵ in the —NR⁴R⁵ group and R⁶ in the —OR⁶ group according to the group R² include the groups exemplified as the monovalent organic group representing the group R¹.

Each of these groups R⁴ to R⁶ is preferably a hydrogen atom, an alkyl group, an aryl group, an acyl group, an alkylsulfonyl group, a carbamoyl group, and a heterocyclic group, and particularly preferably a hydrogen atom, an alkyl group, an aryl group, and an acyl group.

In addition, in General formula (1), R³ represents a hydroxyl group, an alkoxy group, an aryloxy group, an amino group, an amide group, an alkylsulfonylamino group or an arylsulfonylamino group.

This group R³ is preferably a hydroxyl group, an alkoxy group, an amino group, an amide group, and an alkylsulfonylamino group.

Examples of each of the alkoxy group, the aryloxy group, the amino group, the alkylsulfonylamino group, and the arylsulfonylamino group representing the group R³ include the groups exemplified as the monovalent organic group representing the group R¹.

In addition, in General formula (1), A¹ to A³ each independently represent a —CR⁷═ group (R⁷ represents a hydrogen atom, a halogen atom or a monovalent organic group), or a —N═ group.

Each of the groups A¹ and A² is preferably a —CR⁷═ group.

Examples of the monovalent organic group representing R⁷ in the —CR⁷═ group according to the group A¹ to the group A³ include the groups exemplified as the monovalent organic group representing the group R¹.

This group R⁷ is preferably a hydrogen atom, a halogen atom, an alkyl group, an alkoxy group, and an alkoxycarbonyl group, and particularly preferably a hydrogen atom, an alkyl group, and an alkoxy group.

In General formula (1), X¹ represents an atomic group necessary to form a 5- or 6-membered aromatic or heterocyclic ring.

Examples of the 5- or 6-membered aromatic or heterocyclic ring formed by the atomic group representing the group X¹ include a benzene ring, a naphthalene ring, a pyridine ring, a pyrazine ring, a furan ring, a thiophene ring, an imidazole ring, and a thiazole ring. A benzene ring, a pyridine ring, a thiophene ring, and a thiazole ring are preferable.

In General formula (1), L¹ represents a linking group having 1 or 2 carbon atoms or a part of a ring structure.

This linking group or the part of a ring structure may be bonded to R³ to form a 5- or 6-membered ring structure.

Examples of the linking group which has 1 or 2 carbon atoms and represents the group L include a methylene group, an ethylene group, and an ethyne group, which are unsubstituted or have a substituent.

In addition, examples of the part of a ring structure representing the group L¹ include a group represented by the following General formula (4).

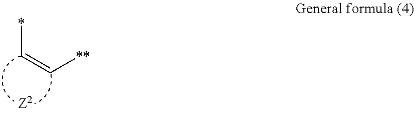

In General formula (4), Z² represents a 5- or 6-membered aromatic or heterocyclic ring, and is bonded to Z¹ in General formula (1) by one bonding arm (the site represented by “*” in General formula (4)) and to R³ in General formula (1) by the other bonding arm (the site represented by “**” in General formula (4)).

In this General formula (4), Z² represents a 5- or 6-membered aromatic or heterocyclic ring, and these aromatic ring and heterocyclic ring may be unsubstituted or may have a substituent.

Examples of the substituent include a halogen atom, an alkoxy group, an amino group, an acylamino group, a sulfonylamino group, and an ureido group, or the like. A halogen atom, an alkoxy group, an amino group, and an acylamino group are preferable.

In addition, the substituent may preferably have a chelatable group. This chelatable group is a substituent containing an atom having an unshared electron pair, and specific examples thereof include a heterocyclic group, a hydroxyl group, a carbonyl group, an oxycarbonyl group, a carbamoyl group, an alkoxy group, a heterooxy group, a carbonyloxy group, a urethane group, a sulfonyloxy group, an amino group, an imino group, a sulfonylamino group, a sulfamoylamino group, an acylamino group, an ureido group, a sulfonyl group, a sulfamoyl group, an alkylthio group, an arylthio group, and a heterocyclic thio group. A hydroxyl group, a carbonyl group, an oxycarbonyl group, a carbamoyl group, an alkoxy group, a carbonyloxy group, a urethane group, a sulfonyloxy group, an amino group, an imino group, a sulfonylamino group, an acylamino group, an ureido group, an alkylthio group and an arylthio group are preferable, and a hydroxyl group, a carbonyl group, a carbamoyl group, an alkoxy group, a sulfonylamino group, and an acylamino group are particularly preferable.

In General formula (1), Z¹ represents an atomic group necessary to form a 5- or 6-membered heterocyclic ring containing at least one nitrogen atom.

The atomic group representing this group Z¹ may be unsubstituted or may have a substituent, or may forma condensed ring with the substituent.

Examples of the 5- or 6-membered heterocyclic ring which is formed by the atomic group representing the group Z¹ and contains at least one nitrogen atom include a pyridine ring, a pyrimidine ring, a quinoline ring, a pyrroline ring, a pyrazoline ring, a pyrazole ring, an imidazoline ring, an imidazole ring, a pyrrole ring, and a pyrazolidine ring (for example, a ring derived from pyrazolidine-3,5-dione), those having a substituent in these rings and those obtained by forming a condensed ring with this substituent.

Preferred specific examples of this group Z¹ include groups represented by the following General formula (5) to General formula (10).

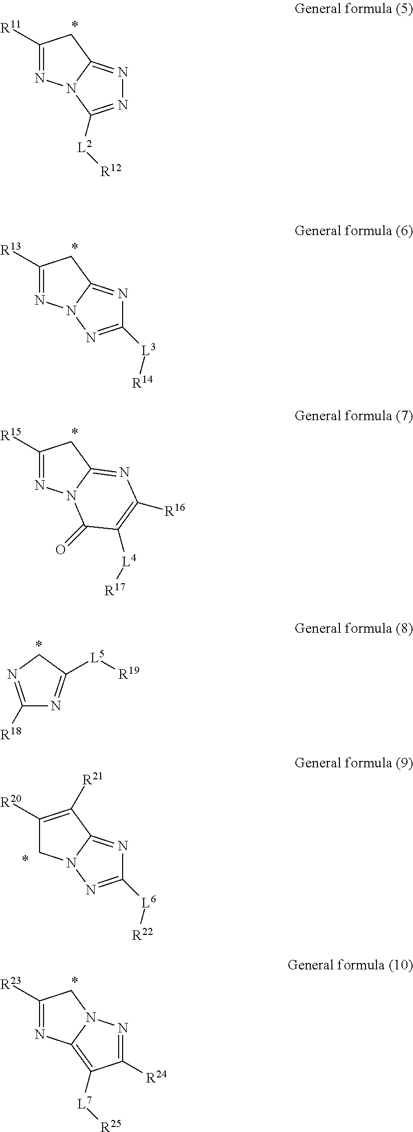

In General formula (5) and General formula (6), each of R¹¹ and R¹³ represents a hydrogen atom, a halogen atom, or a monovalent organic group, each of R¹² and R¹⁴ represents a hydroxyl group, an alkoxy group, an aryloxy group, an amino group, an amide group, an alkylsulfonylamino group or an arylsulfonylamino group, and each of L² and L³ represents a linking group having 1 or 2 carbon atoms or a part of a ring structure and is bonded to A¹ in General formula (1) above at the site represented by “*”.

In addition, in General formula (7), R¹⁵ and R¹⁶ each independently represent a hydrogen atom, a halogen atom, or a monovalent organic group, and R¹⁷ represents a hydroxyl group, an alkoxy group, an aryloxy group, an amino group, an amide group, an alkylsulfonylamino group, or an arylsulfonylamino group. L⁴ represents a linking group having 1 or 2 carbon atoms or a part of a ring structure and is bonded to A₁ in General formula (1) above at the site represented by “*”.

In addition, in General formula (8), R¹⁸ represents a hydrogen atom, a halogen atom, or a monovalent organic group, and R¹⁹ represents a hydroxyl group, an alkoxy group, an aryloxy group, an amino group, an amide group, an alkylsulfonylamino group, or an arylsulfonylamino group. L⁵ represents a linking group having 1 or 2 carbon atoms or a part of a ring structure and is bonded to A¹ in General formula (1) above at the site represented by “*”.

In addition, in General formula (9), R²⁰ and R²¹ each independently represent a hydrogen atom, a halogen atom, or a monovalent organic group, and R²² represents a hydroxyl group, an alkoxy group, an aryloxy group, an amino group, an amide group, an alkylsulfonylamino group, or an arylsulfonylamino group. L⁶ represents a linking group having 1 or 2 carbon atoms or a part of a ring structure and is bonded to A¹ in General formula (1) above at the site represented by “*”.

In addition, in General formula (10), R²³ and R²⁴ each independently represent a hydrogen atom, a halogen atom, or a monovalent organic group, and R²⁵ represents a hydroxyl group, an alkoxy group, an aryloxy group, an amino group, an amide group, an alkylsulfonylamino group, or an arylsulfonylamino group. L⁷ represents a linking group having 1 or 2 carbon atoms or a part of a ring structure and is bonded to A¹ in General formula (1) above at the site represented by “*”.

Examples of the monovalent organic group representing each of R¹¹ and R¹³ in General formula (5) and General formula (6) include the groups exemplified as the monovalent organic group representing R¹ in General formula (1) above.

Each of these groups R¹¹ and R¹³ is preferably a hydrogen atom, an alkyl group, an alkenyl group, an aryl group, a heterocyclic group, an acylamino group, an alkylsulfonylamino group, an arylsulfonylamino group, an amino group, an alkylthio group, an arylthio group, an alkoxy group, an aryloxy group, an ureido group, an alkoxycarbonylamino group, a carbamoyl group, a carboxyl group, or an alkoxycarbonyl group, even more preferably an alkyl group, a carboxyl group, an alkoxy group, or a carbamoyl group, and particularly preferably an alkyl group (particularly, a methyl group, a tert-butyl group, or a trifluoromethyl group), a carbamoyl group, or an alkoxycarbonyl group.

Each of R¹² and R¹⁴ in General formula (5) and General formula (6) is synonymous with R³ in General formula (1) above, and a preferred group thereof is also synonymous with that of R³ in General formula (1) above.

In addition, each of L² and L³ in General formula (5) and General formula (6) is synonymous with L¹ in General formula (1) above, and a preferred group thereof is also synonymous with that of L in General formula (1) above.

Examples of the monovalent organic group representing each of R¹⁵, R¹⁶ and R¹⁸ in General formula (7) and General formula (8) include the groups exemplified as the monovalent organic group representing R¹ in General formula (1) above.

This group R¹⁵ is preferably a hydrogen atom, an alkyl group, an aryl group, a heterocyclic group, a carbamoyl group, an alkoxycarbonyl group, an aryloxycarbonyl group, a cyano group, a sulfamoyl group, an alkylsulfonyl group, or an arylsulfonyl group, and even more preferably an aryl group, a heterocyclic group, a carbamoyl group, an alkoxycarbonyl group, or a cyano group.

In addition, the group R¹⁶ is preferably a hydrogen atom, a halogen atom, an alkyl group, an acylamino group, an alkoxycarbonyl group, an amino group, an alkylthio group, or an arylthio group, and even more preferably a hydrogen atom, a halogen atom, an alkyl group, or an acylamino group.

In addition, the group R¹⁸ is preferably a hydrogen atom, an alkyl group, an aryl group, a heterocyclic group, an acylamino group, an alkylsulfonylamino group, an arylsulfonylamino group, an amino group, an alkylthio group, an arylthio group, an alkoxy group, an aryloxy group, an ureido group, an alkoxycarbonylamino group, an acyl group, an alkoxycarbonyl group, or a carbamoyl group, and even more preferably a hydrogen atom, an alkyl group, an aryl group, a heterocyclic group, an acylamino group, or an alkoxy group.

Each of R¹⁷ and R¹⁹ in General formula (7) and General formula (8) is synonymous with R³ in General formula (1) above, and a preferred group thereof is also synonymous with that of R³ in General formula (1) above.

In addition, each of L⁴ and L⁵ in General formula (7) and General formula (8) is synonymous with L¹ in General formula (1) above, and a preferred group thereof is also synonymous with that of L¹ in General formula (1) above.

Examples of the monovalent organic group representing each of R²⁰, R²¹, R²³, and R²⁴ in General formula (9) and General formula (10) include the groups exemplified as the monovalent organic group representing R¹ in General formula (1) above.

Each of these groups R²⁰ and R²¹ is preferably a hydrogen atom, an alkyl group, an aryl group, a heterocyclic group, a carbamoyl group, an alkoxycarbonyl group, an aryloxycarbonyl group, a carboxyl group, a cyano group, a sulfamoyl group, an alkylsulfonyl group, an arylsulfonyl group, or a nitro group, and even more preferably an alkoxycarbonyl group or a cyano group.

In addition, each of these groups R²³ and R²⁴ is preferably a hydrogen atom, an alkyl group, an aryl group, a heterocyclic group, an acylamino group, an alkylsulfonylamino group, an arylsulfonylamino group, an amino group, an alkylthio group, an arylthio group, an alkoxy group, an aryloxy group, an ureido group, an alkoxycarbonylamino group, an acyl group, a carboxyl group, an alkoxycarbonyl group, or a carbamoyl group, and even more preferably a hydrogen atom, an alkyl group, an aryl group, an acyl group, an acylamino group, an alkoxycarbonyl group, or a carbamoyl group.

In addition, each of R²² and R²⁵ in General formula (9) and General formula (10) is synonymous with R³ in General formula (1) above, and a preferred group thereof is also synonymous with that of R³ in General formula (1) above.

In addition, each of L⁶ and L⁷ in General formula (9) and General formula (10) is synonymous with L¹ in General formula (1) above, and a preferred group thereof is also synonymous with that of L¹ in General formula (1) above.

Specific examples of the compound represented by this General formula (1) include compounds represented by the following General formula (1-1) to General formula (1-20). Meanwhile, the colorant compound precursors will be denoted by the following numbers in Examples to be described below.

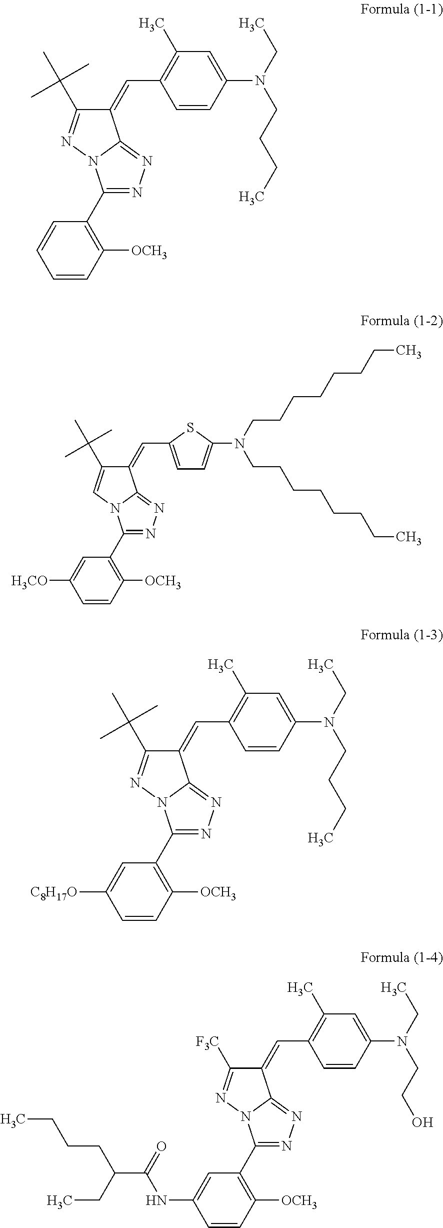

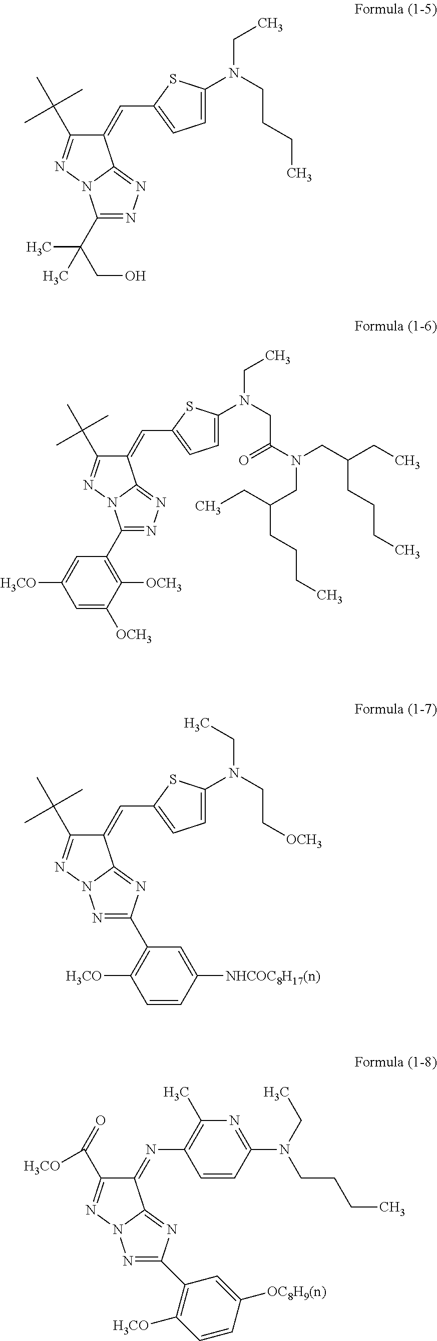

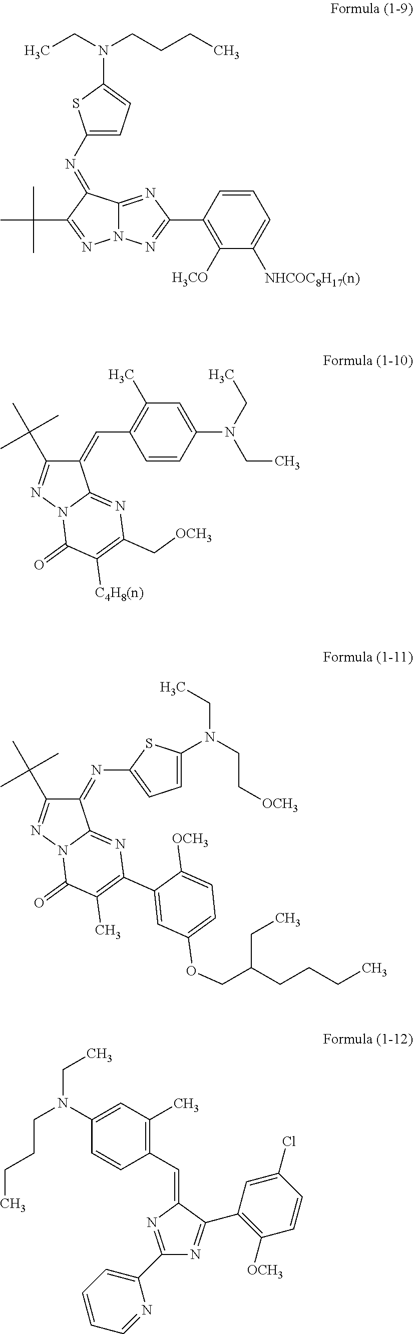

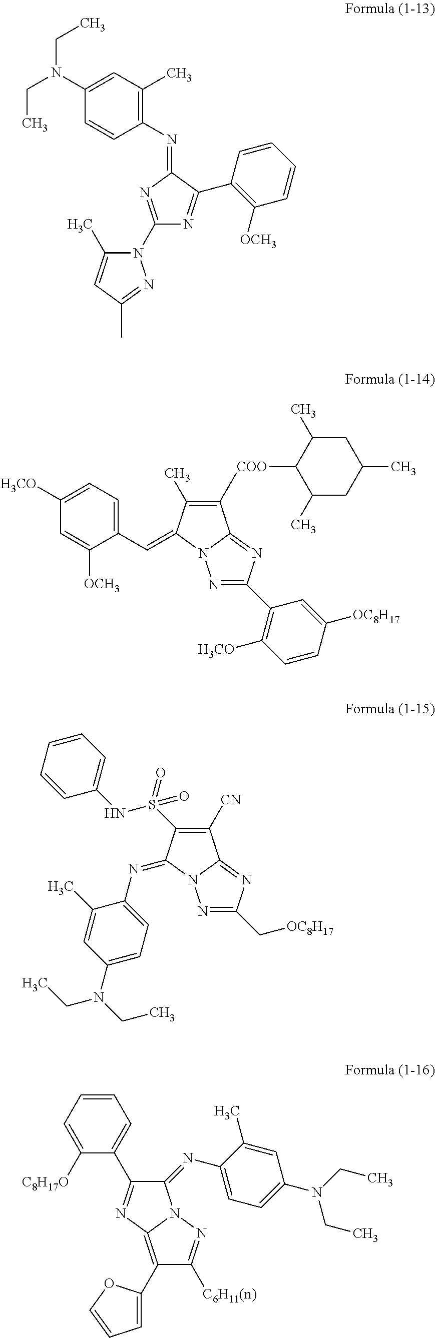

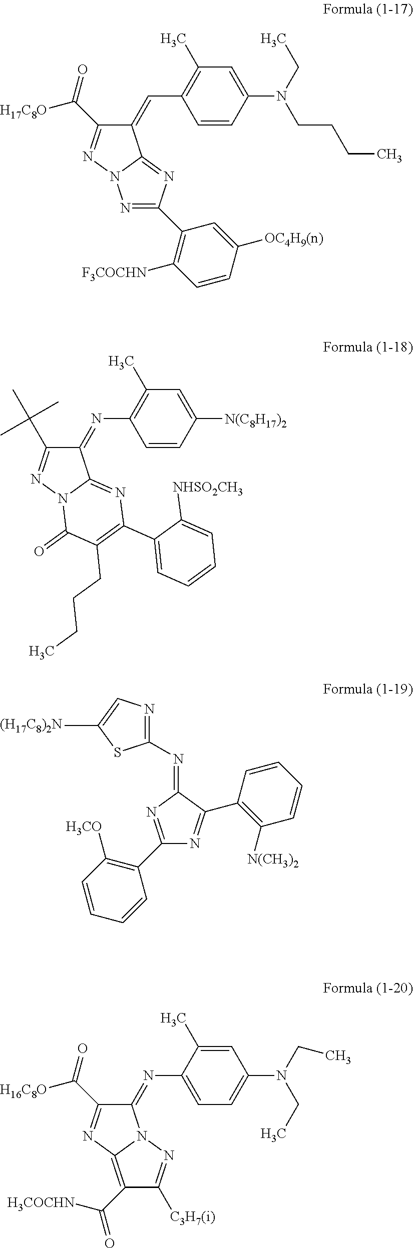

Hereinafter, a compound represented by General formula (2) will be described.

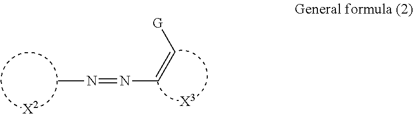

In General formula (2) above, X² represents an atomic group necessary to form an aromatic carbocyclic or heterocyclic ring in which at least one ring is composed of 5 to 7 atoms, and the atomic group necessary to form a heterocyclic ring has a carbon atom bonded to an azo bond and at least one of adjacent positions of this carbon atom is a nitrogen atom or a structure in which a carbon atom in the carbocyclic ring is substituted with a nitrogen atom, an oxygen atom or a sulfur atom. X³ represents an atomic group necessary to form an aromatic carbocyclic or heterocyclic ring in which at least one ring is composed of 5 to 7 atoms, and G represents a hydroxyl group, an amino group, a methoxy group, a thiol group or a thioalkoxy group.

The atomic group representing the group X² may be unsubstituted or may have a substituent.

The aromatic carbocyclic or heterocyclic ring formed by the atomic group representing the group X², in which at least one ring is composed of 5 to 7 atoms, is preferably a benzene ring, a naphthalene ring, a pyridine ring and a quinoline ring.

In addition, examples of the preferred substituent according to the atomic group representing the group X² include a hydroxyl group, an alkyl group (for example, a methyl group, an ethyl group, or the like), an alkoxy group (for example, a methoxy group, an ethoxy group, or the like), a cyano group, a nitro group, a thiol group, a thioalkoxy group, and a halogen atom.

In addition, in General formula (2), X³ represents an atomic group necessary to form an aromatic carbocyclic or heterocyclic ring in which at least one ring is composed of 5 to 7 atoms, and may be unsubstituted or may have a substituent.

The aromatic carbocyclic or heterocyclic ring formed by the atomic group representing the group X³, in which at least one ring is composed of 5 to 7 atoms, is preferably a benzene ring, a naphthalene ring, a pyridine ring, and a quinoline ring. In addition, the substituent is preferably an alkyl group, an alkoxy group, a cyano group, a nitro group, a hydroxyl group, an amino group, and a halogen atom.

In addition, in General formula (2), G represents a hydroxyl group, an amino group, a methoxy group, a thiol group or a thioalkoxy group.

Specific examples of the compound represented by this General formula (2) include compounds represented by the following General formulas (2-1) to (2-5). Meanwhile, the colorant compound precursors will be defined by the following numbers in Examples to be described below.
Formula (2-1) 1-(2-pyridylazo)-2-naphthol
Formula (2-2) 2-(2-hydroxyphenylazo)-5-hydroxypyridine
Formula (2-3) 1-(2-hydroxyphenylazo)-2-naphthol
Formula (2-4) 2-(2-hydroxyphenylazo)-5-methoxyphenol
Formula (2-5) 8-(2-hydroxyphenylazo)-quinoline

The colorant compound precursor is preferably a colorant compound precursor which provides a colorant compound of a magenta color after a reaction. In other words, the colorant compound precursor is preferably a compound represented by General formula (1). The magenta toner produced by the method of JP 2009-282351 A is excellent from the view point of the color tone control, but the fluidity and storage stability of the toner may be insufficient as described above. However, the fluidity and the storage stability can be particularly improved by adopting the constitution of the toner of the present invention to the magenta toner.

The content proportion of the colorant compound precursor is adjusted such that the content proportion of the colorant in the toner (toner particles) after heat fixing is in a desired range and varies depending on the colorant compound precursor used, but is preferably from 0.15 to 4 parts by mass and even more preferably from 1 to 3 parts by mass with respect to 100 parts by mass of the toner (including other components such as an external additive to be described below).

(Metal-Containing Compound)

The metal-containing compound contained in the toner of the present invention is a compound that reacts with the colorant compound precursor described above by heat applied at heat fixing. The metal-containing compound is dispersed in the resin particles (or the surface of the resin particles), similarly to the colorant compound precursor, and present in a state of not reacting with the colorant compound precursor at room temperature (during storage), but provides a colorant compound through a reaction with the colorant compound precursor by heat applied at heat fixing. Hence, the metal-containing compound used is preferably solid at room temperature in order to improve the fluidity and storage stability of the toner to be obtained.

The metal-containing compound is preferably a metal coordination compound or an organometallic compound. The metal-containing compound contained in the toner of the present invention reacts with the colorant compound precursor to form a metal chelate coloring matter. Hence, the metal-containing compound is more preferably a metal coordination compound.

In a case in which the metal-containing compound is an organometallic compound, not the organometallic compound itself, but it is also possible to supply, for example, an inorganic metal salt such as copper sulfate together with an organic compound.

The metal coordination compound is preferably a compound represented by the following General formula (A).

Mⁿ⁺(X)ₘ General formula (A)

In General formula (A), M represents a metal atom, and n represents the valence of M and is generally from 0 to 8 although the valence is definitely determined by the kind of M. Among them, M is preferably a divalent (n=2) metal in order to improve the color of the metal-containing compound and the color tone of the colorant compound obtained by the reaction with the colorant compound precursor. X represents a ligand capable of forming a complex with a metal ion having a valence of n. The ligand X may be an anion or a neutral ligand according to the valence of the metal atom. m is the number of the ligand X, and is from 1 to 8, preferably from 1 to 4, and more preferably from 1 to 2.

More specifically, the metal-containing compound is preferably a compound represented by General formula (3).

Hereinafter, the compound represented by General formula (3) will be described.

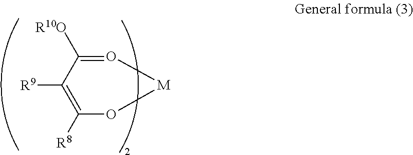

In General formula (3), M represents a divalent metal atom, R⁸ represents a hydrogen atom or a monovalent organic group, R⁹ represents a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group, or a cyano group, and R¹⁰ represents a hydrogen atom, an alkyl group, an alkenyl group, an alkynyl group, an aryl group, an arylalkyl group, or a heterocyclic group.

In General formula (3) that represents the metal-containing compound, M represents a divalent metal atom, and is preferably a divalent transition metal atom.

As the group M, a nickel atom, a copper atom, and a zinc atom are preferable and a copper atom is most preferable among the divalent transition metal atoms from the viewpoint of producing a metal coordination compound with the colorant compound precursor including a compound represented by General formula (1) or a compound represented by General formula (2) and the stability of the color tone of the toner to be finally obtained.

In General formula (3), R⁸ represents a hydrogen atom or a monovalent organic group.

Examples of the monovalent organic group representing the group R⁸ include an alkyl group having from 1 to 20 carbon atoms (for example, a methyl group, an ethyl group, a propyl group, an i-propyl group, a t-butyl group, a pentyl group, a hexyl group, an octyl group, a dodecyl group, a tridecyl group, a tetradecyl group, a pentadecyl group, a chloromethyl group, a trifluoromethyl group, a trichloromethyl group, a tribromomethyl group, a pentafluoroethyl group, a methoxyethyl group, or the like), a cycloalkyl group having from 3 to 20 carbon atoms (for example, a cyclopentyl group, a cyclohexyl group, or the like), an alkenyl group having from 2 to 20 carbon atoms (for example, a vinyl group, an allyl group, or the like), an alkynyl group having from 2 to 20 carbon atoms (for example, an ethynyl group, a propargyl group, or the like), an aryl group having from 6 to 20 carbon atoms (for example, a phenyl group, a naphthyl group, a p-nitrophenyl group, a p-fluorophenyl group, a p-methoxyphenyl group, or the like), a heterocyclic group having from 2 to 20 carbon atoms (for example, a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazolyl group, a phthalazyl group, a pyrrolidinyl group, an imidazolidyl group, a morphoryl group, oxazolidyl group, or the like), an alkoxycarbonyl group having from 2 to 20 carbon atoms (for example, a methoxycarbonyl group, an ethoxycarbonyl group, a butoxycarbonyl group, an octyloxycarbonyl group, a dodecyloxycarbonyl group, or the like), an aryloxycarbonyl group having from 7 to 20 carbon atoms (for example, a phenyloxycarbonyl group, a naphthyloxycarbonyl group, or the like), a sulfamoyl group having from 1 to 20 carbon atoms (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, a 2-pyridylaminosulfonyl group, or the like), an acyl group having from 2 to 20 carbon atoms (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a benzoyl group, a naphthylcarbonyl group, a pyridylcarbonyl group, or the like), a carbamoyl group having from 1 to 20 carbon atoms (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, a 2-pyridylaminocarbonyl group, or the like), an alkylsulfinyl group having from 1 to 20 carbon atoms (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, a 2-pyridylsulfinyl group, or the like), an alkylsulfonyl group having from 1 to 20 carbon atoms (for example, a methylsulfonyl group, an ethylsulfonyl group, a butylsulfonyl group, a cyclohexylsulfonyl group, a 2-ethylhexylsulfonyl group, a dodecyl sulfonyl group, or the like), an arylsulfonyl group having from 6 to 20 carbon atoms (for example, a phenylsulfonyl group, a naphthylsulfonyl group, a 2-pyridylsulfonyl group, or the like), and a cyano group, which are substituted or unsubstituted.

The group R⁸ is preferably a hydrogen atom, an alkyl group, an alkenyl group, an aryl group, a heterocyclic group, an alkoxycarbonyl group, an acyl group, a carbamoyl group, or a cyano group, and most preferably a hydrogen atom, an alkyl group, an aryl group, a heterocyclic group, an alkoxycarbonyl group, or a cyano group. These monovalent organic groups exemplified as the preferred group may be unsubstituted or may have a substituent.

In General formula (3), R⁹ represents a hydrogen atom, an alkyl group, an alkenyl group, an alkynyl group, an aryl group, a heterocyclic group, an alkoxycarbonyl group, an aryloxycarbonyl group, a carbamoyl group, a sulfamoyl group, a sulfinyl group, an alkylsulfonyl group, an arylsulfonyl group or a cyano group.

Specific examples of each of the organic groups representing the group R⁹ will be described below.

Examples of the alkyl group include a methyl group, an ethyl group, a propyl group, an i-propyl group, a t-butyl group, a pentyl group, a hexyl group, an octyl group, a dodecyl group, a tridecyl group, a tetradecyl group, a pentadecyl group, a chloromethyl group, a trifluoromethyl group, a trichloromethyl group, a tribromomethyl group, a pentafluoroethyl group, and a methoxyethyl group, or the like.

Examples of the alkenyl group include a vinyl group and an allyl group, or the like.

Examples of the alkynyl group include an ethynyl group and a propargyl group, or the like.

Examples of the aryl group include a phenyl group, a naphthyl group, a p-nitrophenyl group, a p-fluorophenyl group, and a p-methoxyphenyl group, or the like.

Examples of the heterocyclic group include a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazolyl group, a phthalazyl group, a pyrrolidyl group, an imidazolidyl group, a morphoryl group, and an oxazolidyl group, or the like.

Examples of the alkoxycarbonyl group include a methoxycarbonyl group, an ethoxycarbonyl group, a butoxycarbonyl group, an octyloxycarbonyl group, and a dodecyloxycarbonyl group, or the like.

Examples of the aryloxycarbonyl group include a phenyloxycarbonyl group and a naphthyloxycarbonyl group, or the like.

Examples of the carbamoyl group include an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, and a 2-pyridylaminocarbonyl group, or the like.

Examples of the sulfamoyl group include an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, and a 2-pyridylaminosulfonyl group, or the like.

Examples of the sulfinyl group include a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, and a 2-pyridylsulfinyl group, or the like.

Examples of the alkylsulfonyl group include a methylsulfonyl group, an ethylsulfonyl group, a butylsulfonyl group, a cyclohexylsulfonyl group, a 2-ethylhexylsulfonyl group, and a dodecylsulfonyl group, or the like.

Examples of the arylsulfonyl group include a phenylsulfonyl group, a naphthylsulfonyl group, and a 2-pyridylsulfonyl group, or the like.

The group R⁹ is preferably a hydrogen atom, an alkyl group, an aryl group, a heterocyclic group, an alkoxycarbonyl group, or a cyano group, and most preferably a hydrogen atom, an alkyl group, an alkoxycarbonyl group, an aryl group, a heterocyclic group, or a cyano group. These monovalent organic groups exemplified as the preferred group may be unsubstituted or may have a substituent.

In General formula (3), R¹⁰ represents a hydrogen atom, an alkyl group, an alkenyl group, an alkynyl group, an aryl group, an arylalkyl group or a heterocyclic group.

Specific examples of each of the organic groups representing the group R¹⁰ will be described below.

Examples of the alkyl group include a methyl group, an ethyl group, a propyl group, an i-propyl group, a sec-butyl group, a t-butyl group, a pentyl group, a hexyl group, an octyl group, a dodecyl group, a tridecyl group, a tetradecyl group, and a pentadecyl group, or the like.

Examples of the alkenyl group include a vinyl group and an allyl group, or the like.

Examples of the alkynyl group include an ethynyl group and a propargyl group, or the like.

Examples of the aryl group include a phenyl group, a naphthyl group, a p-nitrophenyl group, a p-fluorophenyl group, and a p-methoxyphenyl group, or the like.

Examples of the arylalkyl group include a benzyl group and a phenylethyl group, or the like.

Examples of the heterocyclic group include a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazolyl group, a phthalazyl group, a pyrrolidyl group, an imidazolidyl group, a morphoryl group, and an oxazolidyl group, or the like.

The group R¹⁰ is preferably an alkyl group, an alkenyl group, an alkynyl group, an aryl group, or an arylalkyl group, and most preferably an alkyl group, an aryl group, or an arylalkyl group. These monovalent organic groups exemplified as the preferred group may be unsubstituted or may have a substituent.

In addition, in General formula (3), R⁸ and R⁹ or R⁹ and R¹⁰ may be linked to each other to form a 5- or 6-membered ring.

Moreover, in this General formula (3), it is even more preferable that one of R⁸ and R⁹ be an electron withdrawing group, and it is most preferable that the sum of the value of σρ of R⁸ and R⁹ be from 0.2 to 2.0.

Here, the term “electron withdrawing group” means a substituent capable of having a positive substituent constant σ according to the Hammett equation, and the substituent constant in the Hammett equation is defined as σ in the Hammett equation: log(k/k0)=ρσ which holds when the reaction rate constants of the unsubstituted compound and the compound having a substituent with a meta-substituted aromatic compound or a para-substituted aromatic compound are given as k0 and k, respectively.

Meanwhile, the reaction constants ρ of the dissociation reaction of benzoic acid and the dissociation reaction of a derivative thereof in an aqueous solution at 25° C. are taken as 1 in the Hammett equation above. In addition, it is possible to refer to Journal of Medicinal Chemistry, 1973, Vol. 16, No. 11, 1207-1216, or the like with regard to the substituent constant of Hammett equation.

Specific examples of the electron withdrawing group include an alkyl group having a substituent (for example, a halogen-substituted alkyl group, or the like), an alkenyl group having a substituent (for example, a cyanovinyl group, or the like), an alkynyl group unsubstituted or having a substituent (for example, a trifluoromethylacetylenyl group, a cyanoacetylenyl group, or the like), an aryl group having a substituent (for example, a cyanophenyl, or the like), a heterocyclic group unsubstituted or having a substituent (for example, a pyridyl group, a triazinyl group, a benzoxazolyl group, or the like), a halogen atom, a cyano group, an acyl group (for example, an acetyl group, a trifluoroacetyl group, a formyl group, or the like), a thioacetyl group (for example, a thioacetyl group, a thioformyl group, or the like), an oxalyl group (for example, a methyloxalyl group, or the like), an oxyoxalyl group (for example, an ethoxalyl group, or the like), a thiooxalyl group (for example, an ethylthiooxalyl group, or the like), an oxamoyl group (for example, a methyloxamoyl group, or the like), an oxycarbonyl group (for example, an ethoxycarbonyl group, or the like), a carboxyl group, a thiocarbonyl group (for example, an ethylthiocarbonyl group, or the like), a carbamoyl group, a thiocarbamoyl group, a sulfonyl group, a sulfinyl group, an oxysulfonyl group (for example, an ethoxysulfonyl group, or the like), a thiosulfonyl group (for example, an ethylthiosulfonyl group, or the like), a sulfamoyl group, an oxysulfinyl group (for example, a methoxysulfinyl group, or the like), a thiosulfinyl group (for example, a methylthiosulfinyl group, or the like), a sulfinamoyl group, a phosphoryl group, a nitro group, an imino group, a N-carbonylimino group (for example, a N-acetylimino group, or the like), a N-sulfonylimino group (for example, a N-methanesulfonylimino group, or the like), a dicyanoethylene group, an ammonium group, a sulfonium group, a phosphonium group, a pyrylium group, and an immonium group, or the like.

Among these, an alkyl group having a substituent, an aryl group having a substituent, a cyano group, an acyl group, an oxycarbonyl group, and a nitro group is preferable, and specifically a cyano group, a nitro group, a trichloromethyl group, a dichloromethyl group, a chloromethyl group, a tribromomethyl group, a dibromomethyl group, a bromomethyl group, an alkoxyacyl group, an acyl group, and an aromatic ring substituted with these organic groups are preferable.

Such a metal coordination compound represented by General formula (3) is preferably a compound obtained by synthesizing a compound represented by the following General formula (11) and causing this compound to react with a compound containing a divalent metal.

Here, these metal coordination compounds may be synthesized based on the method described in “Chelate Chemistry: (5) Complex Chemistry Experimental Method [I] (published by Nankodo Co., Ltd.)” or the like. Examples of the compound containing a divalent metal used in this synthesis include nickel chloride, nickel acetate, magnesium chloride, calcium chloride, barium chloride, zinc chloride, zinc acetate, titanium(II) chloride, iron(II) chloride, copper(II) chloride, cobalt chloride(II), manganese(II) chloride, lead chloride, lead acetate, mercuric chloride, and mercuric acetate, or the like. Zinc chloride, zinc acetate, nickel chloride, nickel acetate, copper chloride, and copper acetate are preferable and copper acetate is most preferable from the viewpoint of producing a metal coordination compound with a colorant compound precursor including a compound represented by General formula (1) or a compound represented by General formula (2) and the stability of the color tone of toner.

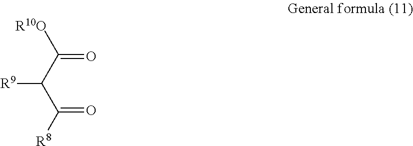

Since R⁸ to R¹⁰ in General formula (11) are synonymous with R⁸ to R¹⁰ in General formula (3), and thus the description thereof will not be presented here.

Specific examples of the metal coordination compound represented by this General formula (3) include compounds represented by the following General formula (3-1) to General formula (3-14). Meanwhile, the metal-containing compounds will be denoted by the following numbers in Examples to be described below.

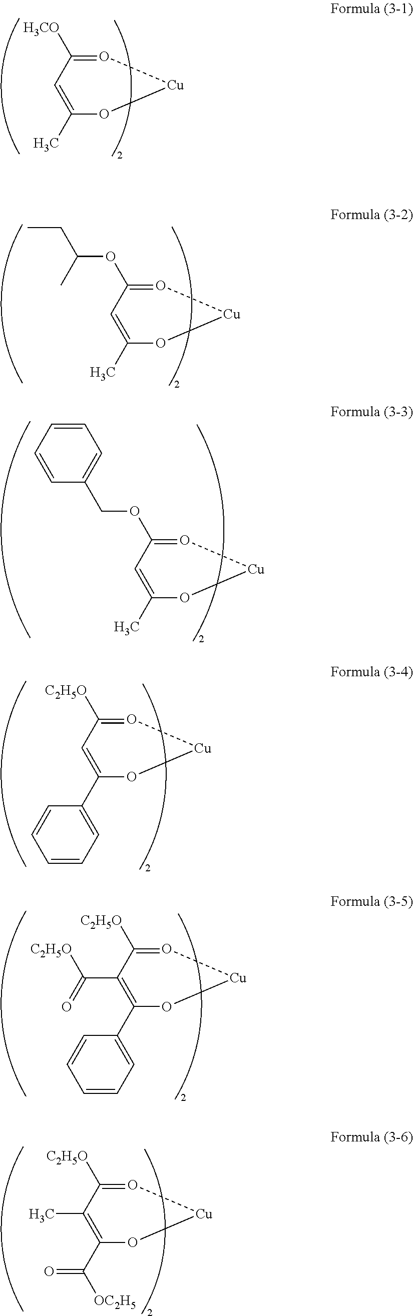

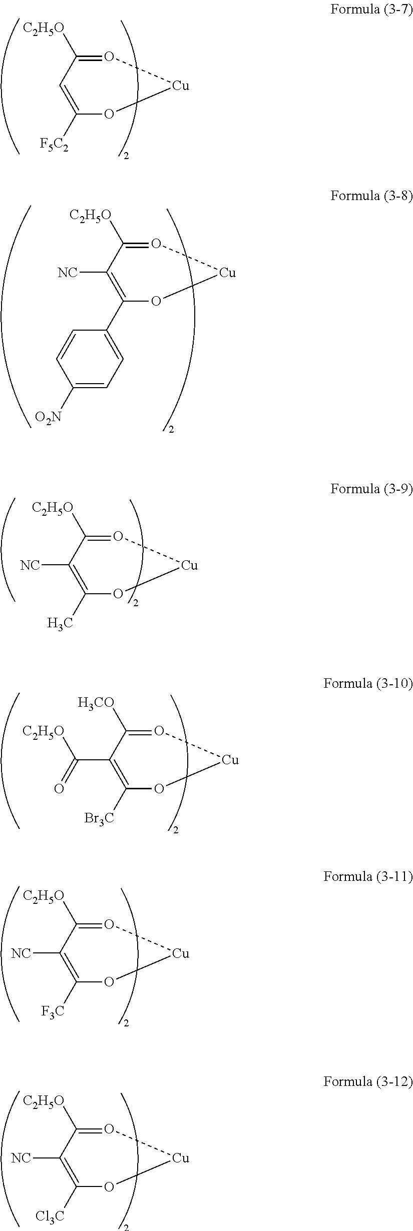

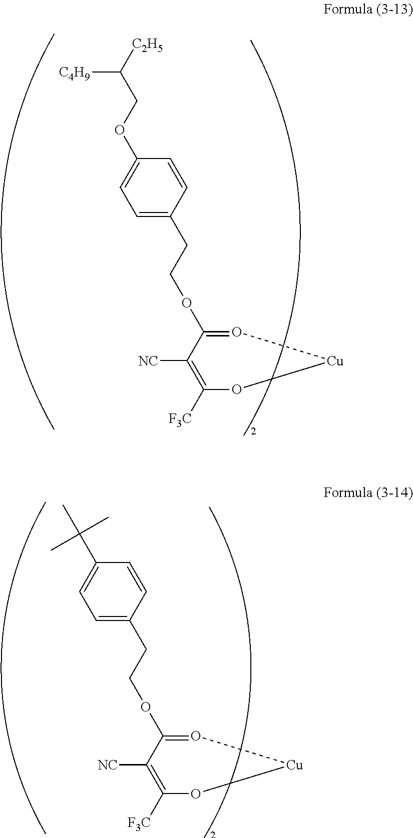

The content proportion of the metal-containing compound is adjusted such that the content proportion of the colorant in the toner (toner particles) after heat fixing is in a desired range and varies depending on the metal-containing compound used, but is preferably from 0.1 to 4 parts by mass and even more preferably from 1 to 3 parts by mass with respect to 100 parts by mass of the toner (total mass including other components such as an external additive to be described below). In addition, the content proportion is preferably from 0.1 to 4 parts by mass and even more preferably from 1 to 3 parts by mass with respect to 100 parts by mass of the resin constituting the toner.

The proportion of the colorant compound precursor to the metal-containing compound described above is preferably from 10:90 to 90:10 and more preferably from 30:70 to 70:30. The colorant compound produced at heat fixing can be obtained in a favorable color tone by setting to such a ratio.

(Other Components)

The toner of the present invention may further contains a release agent, a charge control agent, an external additive, or the like other than the components described above as long as the reaction of the metal-containing compound with the colorant compound precursor is not inhibited.

Release Agent

A well-known release agent can be added to the toner according to the present invention if necessary.

Examples of the release agent (offset inhibitor) include a hydrocarbon-based wax, an ester-based wax, a natural product-based wax, and an amide-based wax, or the like.

Examples of the hydrocarbon-based wax include microcrystalline wax, Fischer-Tropsch wax, and paraffin wax in addition to polyethylene wax and polypropylene wax which have a low molecular weight, or the like.

Examples of the ester-based wax include an ester of a higher fatty acid and a higher alcohol such as behenyl behenate, an ethylene glycol stearic ester, an ethylene glycol behenic ester, stearyl citrate, behenyl citrate, stearyl malate, and behenyl malate. These release agents may be used singly or in combination of two or more kinds thereof.

The melting point of the release agent is preferably from 40 to 160° C. and more preferably from 50 to 120° C. By setting the melting point in the above range, the heat resistant preserving property of the toner is secured and the toner image formation can be stably performed without causing cold offset or the like even in the case of performing the fixing at a low temperature. In addition, the content of the release agent in the toner is preferably from 1 to 30% by mass and more preferably from 5 to 20% by mass.

Charge Control Agent

A well-known charge control agent can be added to the toner of the present invention if necessary. As the charge control agent, a charge control agent dispersable in an aqueous medium can be used. Specific examples thereof include a nigrosin-based dye, a metal salt of naphthenic acid or a higher fatty acid, an alkoxylated amine, a quaternary ammonium salt compound, an azo metal complex, and a metal salt or a metal complex of salicylic acid, or the like. The particles of this charge control agent preferably have a number average primary particle size of about from 10 to 500 nm in a dispersed state.

External Additive

The so-called external additive (also referred to as the “external addition agent”) can be added to the toner of the present invention and used for the purpose of improving the fluidity, electrification property, and cleaning property. These external additives are not particularly limited, and various kinds of inorganic fine particles, organic particles, and lubricants can be used.

As these inorganic fine particles, various kinds of inorganic oxide particles such as silica, titania, and alumina are preferably used. Moreover, these inorganic fine particles are preferably hydrophobic-treated by a silane coupling agent or a titanium coupling agent. In addition, as the organic fine particles, a polymer such as polystyrene, polymethyl methacrylate, and styrene-methyl methacrylate copolymer can be used. As the lubricant, a metal salt of a higher fatty acid can be used, and specific examples thereof include a zinc, aluminum, copper, magnesium, or calcium salt of stearic acid; and a zinc, manganese, iron, copper, or magnesium salt of oleic acid, or the like.

The addition proportion of these external additives, that is, the addition amount of the external additive, is preferably from 0.1 to 4.5 parts by mass in the total of the toner. In addition, various kinds of external additives may be used in combination.

(Softening Point Temperature of Toner)

The softening point temperature (Tsp) of the toner of the present invention is preferably from 90 to 140° C. and more preferably from 100 to 130° C., and particularly preferably from 105 to 120° C.

By having the softening point temperature in the above range, heat applied at heat fixing can be applied to the metal-containing compound and the colorant compound precursor, and the reaction thereof can sufficiently proceed. In addition, an image can be formed without putting a heavy burden on the colorant when the softening point temperature is in the above range, and thus more widely stable color reproducibility of the visible image to be formed can be realized.

In addition, it is possible to perform an environment-friendly image formation achieving a reduction in power consumption since an image can be formed without any adverse effect even when the fixing temperature is significantly low.

The softening point temperature of the toner of the present invention can be controlled, for example, (1) by adjusting the kind or the composition ratio of the polymerizable monomer constituting the resin, (2) by using, for example, a chain transfer agent in the step of obtaining a resin and adjusting the molecular weight of the resin depending on the kind and the use amount of the chain transfer agent in the manufacturing step of toner, (3) by adjusting the kind and the use amount of the constituent material such as a release agent, or by combining these methods of (1) to (3).

As used herein, the softening point temperature of the toner is measured as follows. The “Flow Tester CFT-500” (manufactured by Shimadzu Corporation) is used for the measurement. A cylindrical body with a height of 10 mm is formed using the toner, and this cylindrical body is pushed out of the nozzle with a diameter of 1 mm and a length of 1 mm by applying a pressure of 1.96×10⁶ Pa using a plunger while heating at a temperature rising rate of 6° C./min. In this manner, the softening flow curve showing the relation between the fall out amount from the plunger and the temperature is obtained. The temperature when the fall out amount is 5 mm is adopted as the softening point temperature.

(Median Diameter of Toner Particle)

The particle size of the toner of the present invention is preferably 3 μm or more and 8 μm or less as a volume-based median diameter (D50v).

It is possible to reliably reproduce a significantly fine dot image, for example, a 1200 dpi (dots per inch (2.54 cm)) level by having the volume-based median diameter in the above range. As a result, it is possible to form an image having a high definition which is equal to or higher than the image formed by a printing ink as a photographic image, and thus high color reproducibility of the image can be realized even in the case of forming a photographic image as a visible image. Consequently, a full-color image including a high definition photographic image can be easily formed even in a small quantity of a several hundred pieces level to a several thousand pieces level particularly in the light printing field.

The volume-based median diameter of the toner of the present invention can be measured and calculated using a measuring device, for example, the “Coulter Multisizer TA-III” (manufactured by Beckman Coulter, Inc.) connected with a computer system for data processing (manufactured by Beckman Coulter, Inc.). Specifically, 0.02 g of toner is added to 20 mL of a surfactant solution (for example, a surfactant solution obtained by diluting a neutral detergent containing a surfactant component 10 times with pure water for the purpose of dispersing the toner) and mixed thoroughly and evenly, and then ultrasonic dispersion is performed for 1 minute, thereby preparing a toner dispersion. This toner dispersion is injected into a beaker containing “ISOTONII” (manufactured by Beckman Coulter, Inc.) in the sample stand using a pipette until the concentration indicated by the measuring device becomes 8%. Here, a reproducible measurement value can be obtained by adopting this concentration range. Thereafter, the measuring particle count number and the aperture diameter in the measuring device are set to 25,000 and 50 μm, respectively. The frequency value is calculated by dividing the range of from 1 to 30 μm of the measuring range into 256, and the particle size of 50% from the greater cumulative volume fraction is taken as the volume-based median diameter.

(CV Value of Toner)

The coefficient of variation (CV value) in the volume-based particle size distribution of the toner of the present invention is preferably 2% or more and 21% or less and particularly preferably 5% or more and 15% or less.

The coefficient of variation in the volume-based particle size distribution is a value obtained by expressing the degree of variance in the particle size distribution of the toner particles on a volume basis, and is calculated by the following Mathematical Expression (1).

It indicates that the particle size distribution is sharp as this CV value is smaller, and thus it means that the size of the toner particles is uniform.

$$\begin{matrix}[ Mathematical Expression 1 ] & \\ CV value ( \% ) = \frac{\begin{matrix}standard deviation in number \\ particle size distribution\end{matrix}}{\begin{matrix}median diameter ( D 50 v ) in \\ number particle size distribution\end{matrix}} \times 100 & Equation ( 1 )\end{matrix}$$

Toner having a uniform toner particle size is obtained by having a CV value in the above range, and thus it is possible to more accurately reproduce delicate dots or fine lines as desired in the digital image formation. In addition, it is possible to form an image having a high definition which is equal to or higher than the image formed by a printing ink as a photographic image.

(Structure of Toner)

In the toner of the present invention, the resin is in the form of resin particles (toner base particles), the colorant compound precursor and/or the metal-containing compound are dispersed in the resin particles and/or on the surface of the resin particles, but the resin particles may have a core-shell structure including the core part (referred to as the “core particles” in some cases) and a shell part (referred to as the “shell layer” in some cases).

It is preferable that the toner of the present invention contain the resin particles (toner base particles) in which the metal-containing compound and the colorant compound precursor are contained in an unreacted state, and the toner of the present invention includes all of the following containing forms.

TABLE 1

| | | Colorant | |
|---|---|---|---|
| Form of resin | | compound | Metal-containing |
| particles | Kind | precursor | compound |
| Single layer | A-1 | Inside of | Inside of resin |
| resin | | resin | particles |
| particles | | particles | |
| (not | A-2 | Inside of | Outer surface of |
| core-shell) | | resin | resin particles |
| | | particles | |
| | A-3 | Outer surface | Inside of resin |
| | | of resin | particles |
| | | particles | |
| | A-4 | Outer surface | Outer surface of |
| | | of resin | resin particles |
| | | particles | |
| Core-shell | B-1 | Inside of | Inside of core |
| resin | | core part | part |
| particles | B-2 | Inside of | Inside of shell |
| | | shell part | part |
| | B-3 | Outer surface | Outer surface of |
| | | of shell part | shell part |
| | B-4 | Inside of | Inside of shell |
| | | core part | part |
| | B-5 | Inside of | Outer surface of |
| | | core part | shell part |
| | B-6 | Inside of | Outer surface of |
| | | shell part | shell part |
| | B-7 | Inside of | Inside of core |
| | | shell part | part |
| | B-8 | Outer surface | Inside of core |
| | | of shell part | part |
| | B-9 | Outer surface | Inside of shell |
| | | of shell part | part |

In a case in which the resin particles are single layer resin particles, the colorant compound precursor is preferably dispersed in the resin particles constituting the toner base particles and the metal-containing compound is preferably dispersed on the surface of the resin particles constituting the toner base particles (that is, A-2 in Table 1 above). In other words, it is preferable that the toner of the present invention contains the toner base particles containing a resin, the colorant compound precursor be contained in the toner base particles, and the metal-containing compound be dispersed on the surface of the toner base particles. That is to say, the toner of the present invention preferably contains toner base particles having resin particles, a colorant compound precursor dispersed in the resin particles, and a metal-containing compound dispersed on the surface of the toner base particles. By having such a constitution, the reaction between the colorant compound precursor and the metal-containing compound hardly proceeds during storage as compared with a case in which the colorant compound precursor and the metal-containing compound are uniformly dispersed in the resin particles. As a result, the fluidity and storage stability of the toner to be obtained can be improved.

It is possible to have a state in which the colorant compound precursor and the metal-containing compound are separated in the core part and the shell part, respectively (that is, B-4 to B-9 in Table 1 above) in a case in which a core-shell structure is adopted as the structure of the resin particles. As a result, the reaction between the colorant compound precursor and the metal-containing compound in the toner base particles is suppressed during manufacture and storage, and thus the substances are more easily preserved. As a result, the fluidity and storage stability of toner can be favorably maintained. In addition, the colorant compound precursor is preferably contained in the core part (that is, B-4 and B-5 in Table 1 above) in the case of forming the core-shell type toner base particles. In this manner, it is possible to obtain toner equipped with high dispersibility and a higher coloring property in the case of containing the colorant compound precursor in the core part.

In addition, the metal-containing compound is preferably in the form of being dispersed on the surface of the resin particles together with the external additive to be described below (that is, B-5 and B-6 in Table 1 above). There is a possibility that the reaction between the colorant compound precursor and the metal-containing compound proceeds to a certain extent by a high temperature at the time of manufacturing toner in a case in which the metal-containing compound is dispersed in the resin. However, it is particularly preferable that the metal-containing compound be in the form of being dispersed on surface of the resin particles together with the external additive since the external addition treatment can be performed at a low temperature and thus the reaction between the colorant compound precursor and the metal-containing compound is suppressed.

Consequently, in the toner base particles, the resin particles preferably have the core-shell structure, and in the resin of the core-shell structure, the colorant compound precursor is preferably contained in the core part and the metal-containing compound is preferably dispersed on surface of the toner base particles together with the external additive (that is, B-5 in Table 1 above). In other words, it is preferable that the toner of the present invention contains toner base particles having a core-shell structure containing a resin, a colorant compound precursor be contained in the core part of the core-shell structure, and a metal-containing compound be dispersed on surface of the toner base particles. In more detail, the toner of the present invention preferably contains resin particles having core particles and a shell layer aggregated on the surface of the core particles, a colorant compound precursor dispersed in the core particles, and a metal-containing compound dispersed on the surface of the shell layer. In this manner, the reaction between the colorant compound precursor and the metal-containing compound hardly proceeds during storage of the toner by disposing the colorant compound precursor and the metal-containing compound via the shell layer interposed therebetween, and thus the fluidity and storage stability of the toner are more improved.

(Developer)

The toner of the present invention can be used as a magnetic or nonmagnetic one-component developer, but may be used as toner (two-component developer) of a two-component developer mixed with a carrier. The toner of the present invention is excellent in fluidity, and thus is excellent in the dispersibility between the toner and the carrier when used as a two-component developer.

A non-magnetic one-component developer or a magnetic one-component developer containing magnetic particles of about from 0.1 to 0.5 μm in the toner are exemplified in a case in which the toner of the present invention is used as a one-component developer, and either of the two can be used.

In addition, It is possible to use magnetic particles including a material well-known in the related art such as a metal including iron, ferrite, and magnetite, and an alloy of those metals and a metal including aluminum and lead as the carrier in a case in which the toner of the present invention is used as a two-component developer, and ferrite particles are particularly preferable.

A coating resin constituting the coated carrier is preferably a substance which exhibits relatively a positive charge with respect to the toner, and examples thereof include an olefin-based resin, a styrene-based resin, an acrylic resin, a styrene-acrylic resin, a silicone-based resin, an ester resin, and a fluorine-containing polymer-based resin, or the like. In addition, the resin constituting the resin dispersion type carrier is not particularly limited, and a well-known resin can be used and examples thereof include an acrylic resin, a styrene-acrylic resin, polyester resin, fluorine resin, and phenol resin, or the like.

Examples of the preferred carrier include a coated carrier coated with acrylic resin as a coating resin from the viewpoint of separation prevention of the external additive and durability.

The volume-based median diameter (D₅₀) of the carrier is preferably from 20 to 100 μm and more preferably from 25 to 80 μm. The volume-based median diameter (D₅₀) of the carrier can be representatively measured by, for example, a laser diffraction particle size distribution measuring apparatus equipped with a wet disperser “HELOS” (manufactured by SYMPATEC).

[Method of Manufacturing a Toner for Electrostatic Charge Image Development]

The present invention also provides a method of manufacturing the toner described above. In other words, a second embodiment of the present invention provides a method of manufacturing a toner for electrostatic charge image development including a step of mixing a resin, a metal-containing compound, and a colorant compound precursor to be converted to a colorant compound through a reaction with the metal-containing compound by heat applied at heat fixing. According to the present embodiment, a method of manufacturing the toner for electrostatic charge image development which is excellent in fluidity and storage stability is provided.

The toner of the present invention can be manufactured by a grinding method performing a mixing and kneading step, a grinding step, and a classifying step in this order, a polymerization method (wet method), for example, such as an emulsion polymerization method, a suspension polymerization method, and a polyester extension method, or the like, but the following method is preferably used in consideration of the production cost and the production stability. In other words, an emulsion association method in which resin particles are formed in advance, and these resin particles are aggregated and fused to form toner particles is preferably exemplified. In the emulsion association method, the colorant compound precursor and the metal-containing compound can be dispersed in the toner without reacting with each other by controlling the conditions of the aggregating and fusing step of the resin particles.

More specifically, the method of manufacturing the toner of the present invention preferably has a step of obtaining a mixture containing a resin and a colorant compound precursor (or a metal-containing compound), obtaining an intermediate through the aggregation and fusion of this mixture by heating, and then further adding a metal-containing compound (a colorant compound precursor in a case in which a mixture of a resin and a metal-containing compound is previously obtained above).

Hereinafter, a manufacturing example of toner by the emulsion association method will be described. In the emulsion association method, toner is manufactured generally through the following steps. Meanwhile, a method in which an intermediate (core particles) containing a resin and a colorant compound precursor is previously obtained and then a metal-containing compound is mixed thereto is exemplified below, but another method may also be acceptable on the condition that the colorant compound precursor and the metal-containing compound do not react with each other in the manufacturing step of toner. For example, it may be a method in which an intermediate (core particles) containing a resin and a metal-containing compound is previously obtained and then a colorant compound precursor is mixed thereto, or a method in which a resin, a metal-containing compound, and a colorant compound precursor are mixed at the same time.

Hereinafter, a preferred form as a method of manufacturing the toner by the emulsion association method will be described. An example of a preferred method of manufacturing the toner of the present invention includes the following steps (a) to (e).

(a) A step of obtaining a dispersion of resin particles;

(b) A step of mixing the dispersion of resin particles and a colorant compound precursor (or a dispersion thereof) and aggregating the resin particles (aggregating and fusing step);

(c) A step of cooling;

(d) A step of filtering, washing, and drying; and

(e) A step of adding a metal-containing compound (external addition treatment step).

Hereinafter, each of the steps will be described.

(a) Step of Obtaining Dispersion of Resin Particles

In this step, a dispersion of the resin particles constituting the toner described above is obtained.

The method of obtaining a dispersion is not particularly limited, and for example, a resin particle dispersion can be obtained by polymerizing the polymerizable monomer described above in an aqueous medium in the presence of the surfactant and the polymerization initiator described above. In addition, examples of the method other than the method described above include a method in which the resin is ground if necessary and then the resin particles are dispersed in an aqueous medium in the presence of a surfactant using an ultrasonic homogenizer or the like.

Here, the aqueous medium refers to a medium including water as the main component (50% by mass or more and 100% by mass or less). Here, as the component other than water, an organic solvent soluble in water can be exemplified and examples thereof include methanol, ethanol, isopropanol, butanol, acetone, methyl ethyl ketone, and tetrahydrofuran, or the like. Among these, an alcohol-based organic solvent such as methanol, ethanol, isopropanol, or butanol of an organic solvent that does not dissolve the resin is particularly preferable.

In the present step, as a method of dispersing the resin particles by polymerizing a polymerizable monomer in an aqueous medium, an emulsion polymerization method is preferably used. In addition, the resin particles may have a multilayer structure of two or more layers including resins having different compositions. Resin particles having such a constitution, for example, a two-layer structure can be obtained by a method in which a dispersion of resin particles is prepared by an emulsion polymerization treatment (first stage polymerization) based on a common method, a polymerization initiator and a polymerizable monomer are added to this dispersion, and this system is subjected to a polymerization treatment (second stage polymerization). At this time, a third stage polymerization may be further performed in the same manner.

The dispersion obtained in the present step preferably further contains an internal additive such as wax.

(b) Step of Mixing Dispersion of Resin Particles and Colorant Compound Precursor (or Dispersion Thereof) and Aggregating Resin Particles (Aggregating and Fusing Step)

This step is a step of obtaining a binder resin by aggregating and fusing the resin particles in a dispersion containing the resin particles and the colorant compound precursor described above in an aqueous medium.

In this step, an alkali metal salt, an alkaline earth metal salt, or the like is added into an aqueous medium obtained by mixing the resin particles and the colorant compound precursor as a flocculant, and then the aggregation of the resin particles are performed by heating at a temperature which is equal to or higher than the glass transition temperature thereof and the fusion of the resin particles is performed at the same time.

Specifically, the dispersion of the resin particles manufactured by the procedure described above and a colorant compound precursor (or dispersion thereof) are mixed, and a flocculant such as magnesium chloride is added thereto, whereby the resin particles and the colorant compound precursor are aggregated at the same time as the particles are fused to form a binder resin. Thereafter, the aggregation is stopped by adding a salt such as saline solution when the size of the aggregated particles has grown to a target size.

The flocculant used in the present step is not particularly limited, but those selected from metal salts are preferably used. Examples thereof include a salt of a monovalent metal such as a salt of an alkali metal including sodium, potassium, and lithium, a salt of a divalent metal including calcium, magnesium, manganese, and copper, and a salt of a trivalent metal including iron and aluminum, or the like. Specific examples of the salt include sodium chloride, potassium chloride, lithium chloride, calcium chloride, magnesium chloride, zinc chloride, copper sulfate, magnesium sulfate, and manganese sulfate, or the like. Among these, a salt of a divalent metal is particularly preferable. The aggregation can proceed with a smaller amount when a salt of a divalent metal is used. These flocculants may be used singly or in combination of two or more kinds thereof.

In the aggregating step, it is preferable that the leaving to stand time to leave to stand (time until heating is started) after the addition of the flocculant be as short as possible. The leaving to stand time is normally within 30 minutes and preferably within 10 minutes.

In addition, in the aggregating step, it is preferable to rapidly increase the temperature by heating after the addition of flocculant, and the temperature rising rate is preferably 0.3° C./min or more. The upper limit of the temperature rising rate is not particularly limited, but is preferably 15° C./min or less from the viewpoint of suppressing the production of coarse particles by the rapid progression of fusion. In addition, in the step of aggregating resin particles, the temperature of the system is set to preferably from 50 to 90° C. and particularly preferably from 60 to 80° C. by adjusting the temperature.

Moreover, it is desirable to continue the fusion (first aging step) by maintaining the temperature of the dispersion for aggregation for a predetermined period of time, and preferably, until the volume-based median diameter becomes from 4.5 to 7.0 μm after the temperature of the dispersion for aggregation reaches equal to or higher than the glass transition temperature. In addition, the first aging step is preferably performed until the average circularity of the particles becomes preferably from 0.900 to 1.000 by measuring thereof during aging. Meanwhile, the average circularity is measured by the method described in Examples.

In this manner, the particle growth (aggregation of the resin particles and the colorant compound precursor) and the fusion (disappearance of the interface between the particles) can be effectively performed, and thus the durability of the toner particles finally obtained can be improved.

Meanwhile, the colorant compound precursor may be added to the dispersion of the resin particles obtained in the step (a) above in the solid state or in a state of a dispersion by preparing in advance. The dispersion of the colorant compound precursor is preferably prepared by preparing an aqueous surfactant solution using the same aqueous medium and surfactant as those in (a) above and then adding the colorant compound precursor to the solution. Examples of the disperser used for the dispersion treatment of the colorant compound precursor include a well-known disperser such as a pressure disperser such as an ultrasonic homogenizer, a mechanical homogenizer, a Manton Gaulin homogenizer, and a pressure discharge type homogenizer, and a medium type disperser such as a sand grinder, a Getzmann mill, and a diamond fine mill.

(b′) Step of Forming Shell Part (Shell Forming Step)

The step (b) above is preferably further followed by a step of forming a sell part in a case in which the toner of the present invention has a core-shell structure. Hence, an emulsion aggregation method is preferably adopted in order to uniformly form a shell layer on the surface of the core particles in the case of obtaining a binder resin with a core-shell structure. In other words, in the first aging step above, an aqueous dispersion of a resin for shell to form the shell part is further added, and the resin for shell is aggregated and fused on the surface of the binder resin particles (core particles) with a single-layer structure obtained above. In this manner, a binder resin having a core-shell structure is obtained (shell forming step). At this time, the shell forming step is preferably further followed by heat treatment (second aging step) of the reaction system in order to enhance the aggregation and fusion of the shell to the surface of the core particles and grow the shape of the particles to the desired shape. The temperature of the system at the time of this heat treatment is preferably from 65 to 95° C. and particularly preferably 70 to 90° C. In addition, the second aging step is performed for preferably from 5 to 35 hours and particularly preferably from 10 to 30 hours.

This second aging step may be performed until the average circularity of the toner base particles having a core-shell structure is in the average circularity range described above. Thereafter, the aggregation is stopped by adding a salt such as saline solution when the size of the aggregated particles has grown to a target size.

The dispersion for the aggregating step may contain a well-known additive such as a dispersion stabilizer, a release agent (offset inhibitor), a surfactant, or a charge control agent as an additive. These additives may be added in the present step as a dispersion of additive or contained in the dispersion of colorant compound precursor or the dispersion of binder resin. Specific examples of the release agent, the surfactant, and the charge control agent are as described above, and thus the description thereof will not be presented here.

It is possible to use the same dispersion stabilizer as those used in order to preserve the polymerizable monomer or the like in an appropriately dispersed state at the time of preparing the resin particles as the dispersion stabilizer, and thus the description thereof will not be presented here.

(c) Step of Cooling

This cooling step is a step to cool the dispersion of toner base particles described above. The cooling rate in the cooling treatment is not particularly limited, but is preferably from 0.2 to 20° C./min. The method of cooling treatment is not particularly limited, and examples thereof include a method to cool by introducing a refrigerant from the outside of the reaction vessel or a method to cool by introducing cold water directly into the reaction system.

(d) Step of Filtering, Washing, and Drying

In the filtering step, the toner base particles are separated from the dispersion of the toner base particles by filtering. The method of filtering treatment is not particularly limited, and examples thereof include a centrifugal separation method, a vacuum filtration method performed using a Nutsche or the like, a filtration method performed using a filter press or the like.

Subsequently, in the washing step, the deposit such as the surfactant or the flocculant is removed from the toner base particles (caked aggregate) separated through the filteration by washing. The washing treatment is a water washing treatment performed until the electrical conductivity of the filtrate becomes, for example, a level of from 5 to 10 μs/cm.

In the drying step, a drying step is performed to the toner base particles that are already subjected to the washing treatment. Examples of the dryer used in the drying step include a well-known dryer such as a spray dryer, a vacuum freeze dryer, and a vacuum dryer, and it is also possible to use a still-standing shelf dryer, a movable shelf dryer, a fluidized bed dryer, a rotary dryer, a stirring type dryer, or the like. The amount of water contained in the toner base particles that are already subjected to the drying treatment is preferably 5% by mass or less and more preferably 2% by mass or less.

In addition, a crushing treatment may be performed in a case in which the toner base particles that are already subjected to drying treatment are aggregated by a weak interparticle attractive force. As the apparatus for crushing treatment, a mechanical crushing apparatus such as a jet mill, a Henschel mixer, a coffee mill, or a food processor can be used.

(e) Step of Adding Metal-Containing Compound (External Addition Treatment Step)

This step is a step to add a metal-containing compound to the toner base particles prepared through the above steps and mix together.

In the present step, the metal-containing compound may be stirred and mixed with the toner base particles. The method of stirring and mixing is not particularly limited, and any of a Henschel mixer, a V type mixer, a rocking mixer, and a Q mixer can be used. The metal-containing compound and toner base particles may be introduced into these mixers at the same time or in order. More specifically, for example, the stirring and mixing is performed at a stirring blade peripheral speed of preferably from 20 to 60 m/s and more preferably from 30 to 50 m/s using a Henschel mixer. In addition, the temperature of the system at this time is preferably from 20 to 50° C. and more preferably from 25 to 45° C. The temperature is preferably 20° C. or higher since the metal-containing compound can be completely attached to the surface of the toner base particles. In addition, it is possible to obtain toner excellent in fluidity and storage stability without allowing the colorant compound precursor and the metal-containing compound contained in the toner base particles to react with each other when the temperature is 50° C. or lower.

Moreover, the stirring and mixing is performed preferably for about from 5 to 30 minutes and more preferably from 10 to 25 minutes.

At this time, another external additive is preferably added and mixed together with the metal-containing compound. Specific examples of the external additive have been described above, and thus the description thereof will not be presented here. As described above, the fluidity and electrification property of toner are improved and improvement in the cleaning property or the like is achieved by adding an external additive. At this time, the metal-containing compound is preferably added in a solid state.

Meanwhile, there is no need to add the metal-containing compound in a case in which the metal-containing compound has already been added during the steps (a) to (d) above by various modifications, but the metal-containing compound is preferably added together with an external additive as in the present step. It is possible to obtain toner containing a metal-containing compound and a colorant compound precursor in an unreacted state through a simple method by performing the external addition treatment of the metal-containing compound together with an external additive. In addition, the metal-containing compound and the colorant compound precursor do not react with each other in the manufacturing step since there is no need to perform a heat treatment at a high temperature after the addition of the metal-containing compound, and thus the fluidity and storage stability of the toner to be obtained are improved.

In addition, the metal-containing compound may be used as a compound as it is, but the following treatment is preferably performed in advance. In other words, it is preferable to use those obtained by dispersing the metal-containing compound in an aqueous surfactant solution to reduce the particle size, thereafter separating the solid from the liquid, washing the wet cake thus obtained, and drying the resultant.

As described above, an example of a preferred method of manufacturing the toner of the present invention is described, but it should be understood that the various changes, substitutions, and alterations could be made hereto without departing from the spirit and scope of the invention.

For example, in a case in which the toner base particles have a core-shell structure, the dispersion containing a resin for shell and a metal-containing compound may be prepared such that the metal-containing compound is dispersed in the shell part and then aggregated when the step (b′) is performed after the step (b) above. In this case, the step (e) above may not be performed. In addition, at this time, a dispersion of the metal-containing compound may be prepared in advance and then added into the dispersion of the resin for shell, or the metal-containing compound in a solid state may be added into the dispersion of the resin for shell as it is. However, the second aging step described above is performed at a temperature lower than the temperature at which the metal-containing compound reacts with the colorant compound precursor to form a chelate in a case in which the shell part is formed by dispersing the metal-containing compound in the shell part. By virtue of this, the metal-containing compound and the colorant compound precursor are dispersed in the toner base particles in an unreacted state.

The toner of the present invention can be manufactured by the steps (a) to (e) above, but the toner of the present invention is further preferably manufactured by the method including following steps.

(i) A step of preparing a dispersion of resin particles having the resin particles containing an internal additive if necessary dispersed in an aqueous medium;

(ii) A step of forming core particles by mixing the dispersion of the resin particles with a colorant compound precursor (or a dispersion thereof), and heating the mixture to aggregate and fuse the resin particles;

(iii) A step of forming toner base particles by forming a shell part on the surface of the core particles in the dispersed system of the core particles (aqueous medium);

(iv) A step of cooling the dispersed system of the toner base particles;

(v) A step of separating the toner base particles from the dispersed system (aqueous medium) of the toner base particles by filteration, washing, and drying the toner base particles; and

(vi) A step of adding a metal-containing compound and an external additive (external addition treatment step).

As described above, the toner of the present invention is preferably manufactured by heating a mixture of a colorant compound precursor and resin particles to form core particles in advance, forming core particles containing the colorant compound precursor, forming a shell part, heating aging, and then performing the external addition treatment of a metal-containing compound. By performing such steps, it is possible to obtain toner containing a metal-containing compound and a colorant compound precursor converted to a colorant compound through the reaction with the metal-containing compound by heat applied at heat fixing by a simple method, and toner excellent in fluidity and storage stability can be obtained.

[Image Forming Method]

The toner of the present invention can be used in a general electrophotographic image forming method. Accordingly, the present invention also provides an image forming method using the toner described above. In other words, a third embodiment of the present invention provides an image forming method including a step of heat fixing the toner image formed by the toner for electrostatic charge image development described above and producing a colorant compound by reacting the colorant compound precursor with the metal-containing compound. According to the present embodiment, an image forming method capable of suppressing the occurrence of image unevenness is provided.

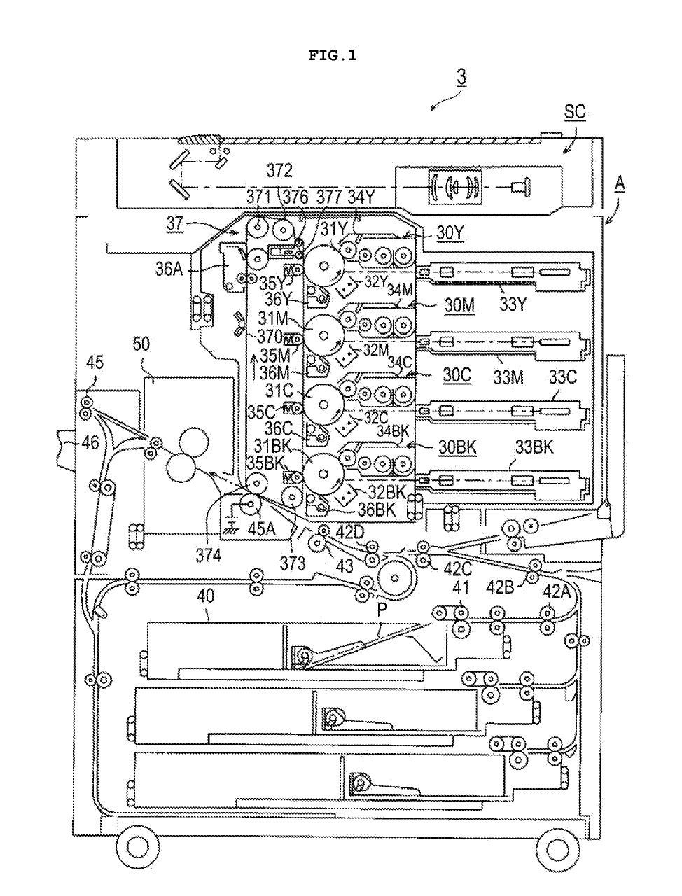

FIG. 1 is a schematic diagram illustrating an example of an image forming apparatus capable of forming a toner image using the toner according to the present invention. It is possible to implement an image forming method typically including the following steps using the toner of the present invention. In other words, a printed matter is produced through

(I) A step of forming an electrostatic latent image by exposing the photoreceptor;

(II) A step of forming a toner image by supplying toner to the photoreceptor having the electrostatic latent image formed thereon;

(III) A step of transferring the toner image formed on the photoreceptor to an image support body; and

(IV) A step of heat fixing the toner image transferred on the image support body. Meanwhile, in the step (IV) above, the colorant compound precursor and the metal-containing compound contained in the toner react with each other by heat applied for heat-fixing to produce the colorant compound.

In FIG. 1, reference numerals 31Y, 31M, 31C, and 31Bk denote a photoreceptor, reference numerals 34Y, 34M, 34C, and 34Bk denote a developing means, reference numerals 35Y, 35M, 35C, and 35Bk denote a primary transfer roller as primary transfer means, reference numerals 36Y, 36M, 36C, and 36Bk denote a cleaning means, reference numeral 37 denotes an endless belt-shaped intermediate transfer body unit, and reference numeral 370 denotes an intermediate transfer body.

This image forming apparatus 3 is referred to as a tandem-type color image forming apparatus, and includes plural sets of image forming units 30Y, 30M, 30C, and 30Bk, an endless belt-shaped intermediate transfer body unit 37 as a transfer unit, an endless belt-shaped fed paper conveying means 41 to convey a recording member P, and a heat roll type fixing device 50 as a fixing means. A document image reading device SC is disposed on the upper part of a body A of the image forming apparatus.

As one of the toner images having different colors formed on respective photoreceptors, the image forming unit 30Y to form an image of yellow color includes a drum-shaped photoreceptor 31Y as a first image carrier, an electrification means 32Y disposed around the photoreceptor 31Y, an exposure means 33Y, a developing means 34Y, a primary transfer roller 35Y as a primary transfer unit, and a cleaning means 36Y. In addition, as another toner image of the toner images having different colors, the image forming unit 30M to form an image of magenta color includes a drum-shaped photoreceptor 31M as a first image carrier, an electrification means 32M disposed around the photoreceptor 31M, an exposure means 33M, a developing means 34M, a primary transfer roller 35M as a primary transfer unit, and a cleaning means 36M.

In addition, as still another toner image of the toner having different colors, the image forming unit 30C to form an image of cyan color includes a drum-shaped photoreceptor 31C as a first image carrier, an electrification means 32C disposed around the photoreceptor 31C, an exposure means 33C, a developing means 34C, a primary transfer roller 35C as a primary transfer unit, and a cleaning means 36C. In addition, as yet another toner image of the toner images having different colors, the image forming unit 30Bk to form an image of black color includes a drum-shaped photoreceptor 31Bk as a first image carrier, an electrification means 32Bk disposed around the photoreceptor 31Bk, an exposure means 33Bk, a developing means 34Bk, a primary transfer roller 35Bk as a primary transfer unit, and a cleaning means 36Bk.

The endless belt-shaped intermediate transfer body unit 37 includes the endless belt-shaped intermediate transfer body 370 which is rotatably supported by being wound around plural rollers and serves as a second intermediate transfer endless belt-shaped image carrier.

The individual color images formed by the image forming units 30Y, 30M, 30C, and 30Bk are sequentially transferred onto the rotating endless belt-shaped intermediate transfer body 370 by the primary transfer rollers 35Y, 35M, 35C, and 35Bk, thereby forming a combined color image. The image support body such as paper as a transfer material accommodated in a paper feeding cassette 40 is fed by the fed paper conveying means 41, conveyed to a secondary transfer roller 45A as a secondary transfer means by passing through plural intermediate rollers 42A, 42B, 42C, and 42D, and a regist roller 43, and the color image is collectively transferred onto the recording member P. The recording member P having the color image transferred thereon is subjected to a fixing treatment by heat roll type fixing device 50 and is carried onto a paper delivery tray 46 located outside the apparatus by being clamped between paper delivery rollers 45.

Meanwhile, the residual toner on the endless belt-shaped intermediate transfer body 370 is removed by a cleaning means 36A after the color image on the endless belt-shaped intermediate transfer body 370 is transferred onto the recording member P by the secondary transfer roller 45A and self-stripping of the recording member P therefrom is performed.

During the image forming treatment, the primary transfer roller 35Bk is in pressure contact with the photoreceptor 31Bk at all times. The other primary transfer rollers 35Y, 35M, and 35C are brought into pressure contact with the respectively corresponding photoreceptors 31Y, 31M, and 31C, only at the time of forming a color image.

The secondary transfer roller 45A is brought into pressure contact with the endless belt-shaped intermediate transfer body 370, only when the recording member P passes therethrough and thus the secondary transfer is performed.

The image forming units 30Y, 30M, 30C, and 30Bk are longitudinally disposed in the vertical direction. The endless belt-shaped intermediate transfer body unit 37 is disposed on the left side of the photoreceptors 31Y, 31M, 31C, and 31Bk in the drawing. The endless belt-shaped intermediate transfer body unit 37 includes the endless belt-shaped intermediate transfer body 370 which is rotatable by being wound around rollers 371,372,373,374, and 376, the primary transfer rollers 35Y, 35M, 35C, and 35Bk, and the cleaning means 36A.

In this manner, a toner image is formed on the photoreceptors 31Y, 31M, 31C, and 31Bk by electrification, exposure, and development, the toner images of respective colors are superimposed on the endless belt-shaped intermediate transfer body 370, the superimposed images are collectively transferred to the recording member P and melted and fixed by applying pressure and heat by the fixing device 50. After the toner image is transferred to the recording member P by the photoreceptors 31Y, 31M, 31C, and 31Bk, the toner being left on the photoreceptors at the time of transfer is cleaned by the cleaning means 36A, and then the return to the cycle of electrification, exposure, and development and thus subsequent image formation is performed.

The fixing temperature (surface temperature of the heating member of the fixing device) is preferably from 120 to 200° C. and more preferably from 140 to 180° C. when the toner image is fixed by applying pressure and heat by the fixing device 50 above. As described above, according to the image forming method using the toner of the present invention, a colorant compound precursor reacts with a metal-containing compound for the first time when the heat fixing is performed to produce a colorant compound. In addition, according to the image forming method of the present invention, a colorant compound having favorable color phase can be produced even when the fixing temperature is relatively a low temperature by appropriately selecting the colorant compound precursor and the metal-containing compound.

As such a combination of compounds, the combination of the colorant compound precursor represented by General formula (1) or (2) above and the metal-containing compound represented by General formula (3) above is preferable, moreover the combination of the colorant compound precursor represented by General formula (1) above and the metal-containing compound represented by General formula (3) above is preferable. According to these combinations, the reaction sufficiently proceeds even when the fixing temperature is relatively a low temperature as the range described above, and thus colorant compound exhibiting favorable color tone can be produced at heat fixing.

Toner supplied into the developing device is unevenly charged and thus the occurrence of density unevenness is concerned when toner exhibiting low fluidity is used. As described above, the toner of the present invention is excellent in fluidity and thus the density unevenness at the time of image formation can be reduced. Such an effect is best exerted particularly in a two-component developing system.

Moreover, the toner of the present invention is excellent in fluidity and thus can be suitably used even in a high-speed machine having the linear velocity of the electrostatic latent image carrier is from 100 to 500 mm/sec.

### EXAMPLES

The effect of the present invention will be described with reference to the following Examples and Comparative Examples. However, the scope of the present invention is not limited to Examples below.

### Example 1

### (1) Preparation of Colorant Compound Precursor Dispersion

An aqueous surfactant solution was prepared by dissolving 11.5 parts by mass of sodium n-dodecylsulfate in 160 parts by mass of ion-exchanged water by stirring. To this aqueous surfactant solution, 20 parts by mass of the compound represented by Formula (1-16) as the colorant compound precursor was added gradually, subsequently, the dispersion treatment was performed using a disperser “CLEARMIX (registered trademark) W-motion CLM-0.8” (manufactured by M Technique Co., Ltd.), thereby preparing a dispersion of colorant compound precursor (hereinafter, referred to as the “colorant compound precursor dispersion (1)”) having particles of the colorant compound precursor dispersed therein.

The volume-based median diameter was measured with respect to the particle size of the particles of the colorant compound precursor in the colorant compound precursor dispersion (1), and the result was 221 nm.

Meanwhile, the volume-based median diameter was measured using the “MICROTRAC UPA-150” (manufactured by Honeywell International, Inc.), under the measurement condition of a sample refractive index of 1.59, a specific gravity of sample of 1.05 (in terms of spherical particles), a solvent refractive index of 1.33, and a solvent viscosity of 0.797 (30° C.) and 1.002 (20° C.), and by introducing ion-exchanged water into the measuring cell to perform a zero point adjustment.

### (2) Preparation of Metal-Containing Compound Particle

A dispersion of metal-containing compound (hereinafter, referred to as the “metal-containing compound particle dispersion (1)”) having particles of the metal-containing compound dispersed therein was prepared by the same method as the preparation method of the colorant compound precursor dispersion above except using 19.4 parts by mass of the metal coordination compound represented by Formula (3-4) as the metal-containing compound instead of the compound (colorant compound precursor) represented by Formula (1-16) in the preparation of the colorant compound precursor dispersion described above.

The volume-based median diameter was measured with respect to the particle size of the particles of the metal-containing compound in the metal-containing compound dispersion (1) under the same measurement condition as in the measurement in the preparation of the colorant compound precursor dispersion described above, and the result was 121 nm.

Thereafter, the solid-liquid separation was performed using a basket type centrifugal separator “MARKIII Model Number 60×40” (manufactured by MATSUMOTO KIKAI CO., LTD.) to form a wet cake of the metal-containing compound particles, and this wet cake was washed repeatedly with ion-exchanged water at 40° C. until the electrical conductivity of the filtrate became 5 μS/cm by a basket type centrifugal separator, thereafter, the washed resultant was moved into the “VU type vibration dryer” (manufactured by CHUO KAKOHKI CO., LTD.) and dried until the moisture content reached 0.5% by mass, thereby obtaining metal-containing compound particles (1).

### (3) Preparation of Resin Particle for Core Particle

(3-1) First Stage Polymerization

Into a reaction vessel equipped with a stirrer, a temperature sensor, a cooling pipe, and a nitrogen gas introducing device, an aqueous surfactant solution prepared by dissolving 4 parts by mass of an anionic surfactant including sodium dodecyl sulfate (C₁₀H₂₁(OCH₂CH₂)₂SO₃Na) in 3040 parts by mass of ion-exchanged water was introduced, a polymerization initiator solution prepared by dissolving 10 parts by mass of potassium persulfate (KPS) in 400 parts by mass of ion-exchanged water was added thereto, and the temperature of the liquid was raised to 75° C. Thereafter, a polymerizable monomer solution including 532 parts by mass of styrene, 200 parts by mass of n-butyl acrylate, 68 parts by mass of methacrylic acid, and 16.4 parts by mass of n-octyl mercaptan was added thereto dropwise over 1 hour, and then the mixture was heated and stirred for 2 hours at 75° C. to perform the polymerization (first stage polymerization), thereby preparing a resin particle dispersion (1H) containing resin particles (1 h).

Meanwhile, the weight average molecular weight of the resin particles (1 h) thus obtained was 16,500.

(3-2) Second Stage Polymerization

Into a flask equipped with a stirring device, a polymerizable monomer solution including 101.1 parts by mass of styrene, 62.2 parts by mass of n-butyl acrylate, 12.3 parts by mass of methacrylic acid, and 1.75 parts by mass of n-octyl mercaptan was introduced, thereafter 93.8 parts by mass of paraffin wax “HNP-57” (manufactured by NIPPON SEIRO CO., LTD.) was added thereto, and the internal temperature thereof was raised to 90° C. to dissolve the mixture, thereby preparing a monomer solution.

Meanwhile, an aqueous surfactant solution prepared by dissolving 3 parts by mass of anionic surfactant used in the first stage polymerization in 1560 parts by mass of ion-exchanged water was introduced into a flask equipped with a stirring device and heated so as to have an internal temperature of 98° C. To this aqueous surfactant solution, 32.8 parts by mass (in terms of solid content) of the resin particles (1 h) obtained in the first stage polymerization was added, a monomer solution containing paraffin wax was further added, and then the resultant was mixed and dispersed over 8 hours using a mechanical disperser having a circulation path “CLEARMIX” (manufactured by M Technique Co., Ltd.), thereby preparing an emulsified particle dispersion containing emulsified particles (oil droplets) having a dispersed particle size of 340 nm.

Subsequently, a polymerization initiator solution prepared by dissolving 6 parts by mass of potassium persulfate in 200 parts by mass of ion-exchanged water was added to this dispersion, and this system was heated and stirred for 12 hours at 98° C. to perform the polymerization (second stage polymerization), thereby preparing a resin particle dispersion (1HM) containing resin particles (1hm).

Meanwhile, the weight average molecular weight of the resin particles thus obtained (1hm) was 23,000.

(3-3) Third Stage Polymerization

A polymerization initiator solution prepared by dissolving 5.45 parts by mass of potassium persulfate in 220 parts by mass of ion-exchanged water was added to the resin particle dispersion (1HM) obtained in the second stage polymerization, and a polymerizable monomer solution including 293.8 parts by mass of styrene, 154.1 parts by mass of n-butyl acrylate, and 7.08 parts by mass of n-octyl mercaptan was added thereto dropwise over 1 hour under a temperature condition of 80° C. After completing the dropwise addition, the resultant was heated and stirred for 2 hours to perform the polymerization (third stage polymerization), and then cooled to 28° C., thereby obtaining a resin particle dispersion containing resin particles for core particles (1).

The weight average molecular weight of the resin particles for core particles (1) thus obtained was 26,800. In addition, the glass transition temperature (Tg) thereof was 50° C.

### (4) Preparation of Resin Particle for Shell

Resin particles for shell (1) was obtained by performing the polymerization by the same method as the first stage polymerization except using 624 parts by mass of styrene, 120 parts by mass of 2-ethylhexyl acrylate, 56 parts by mass of methacrylic acid, and 16.4 parts by mass of n-octyl mercaptan as the polymerizable monomer in the first stage polymerization.

The weight average molecular weight of the resin particles for shell (1) thus obtained was 42,500. In addition, the glass transition temperature (Tg) thereof was 60° C.

### (5) Preparation of Toner Particle

(5-1) Formation of Core Particle

Into the reaction vessel equipped with a stirrer, a temperature sensor, a cooling pipe, and a nitrogen gas introducing device, 420.7 parts by mass of the resin particles for core particles (1), 900 parts by mass of ion-exchanged water, and 42 parts by mass (7 parts by mass in terms of solid content) of the colorant compound precursor dispersion (1) were introduced and stirred, and the internal temperature thereof was adjusted so as to be 30° C., thereafter an aqueous sodium hydroxide solution having a concentration of 5 mol/liter was added thereto to adjust the pH to 9.

Subsequently, an aqueous solution prepared by dissolving 2 parts by mass of magnesium chloride hexahydrate in 1000 parts by mass of ion-exchanged water was added thereto over 10 minutes at 30° C. while stirring. The temperature rising of the mixture was started after leaving to stand for 3 minutes, and the temperature of this system was raised to 65° C. over 60 minutes.

Thereafter, the average particle size of the associated particles was measured by the “Coulter Multisizer 3” (manufactured by Beckman Coulter, Inc.), and an aqueous solution prepared by dissolving 40.2 parts by mass of sodium chloride in 1000 parts by mass of ion-exchanged water was added to the system when the volume-based median diameter became 6.5 μm to stop the particle growth. The system was further heated and stirred for 1 hour at a liquid temperature of 70° C. to continue the fusion, thereby obtaining a core particle-containing liquid (1) containing the core particles (1).

The average circularity was measured with respect to the core particles (1) thus obtained using the “FPIA2100” (manufactured by Sysmex Corporation), and the result was 0.912.

(5-2) Formation of Shell Part

After the temperature of the core particle-containing solution (1) was adjusted to 65° C., 96 parts by mass of the resin particles for shell (1) was added thereto, an aqueous solution prepared by dissolving 2 parts by mass of magnesium chloride hexahydrate in 1000 parts by mass of ion-exchanged water was further added thereto for 10 minutes, and the temperature of the mixture was raised to 70° C. and stirred for 1 hour to fuse resin particles for shell (1) on the surface of the core particles (1), thereafter, the aging treatment was performed for 20 hours at a liquid temperature of 75° C., thereby forming the shell part.

(5-3) Cooling, Filtering, and Drying

Thereafter, an aqueous solution prepared by dissolving 40.2 parts by mass of sodium chloride in 1000 parts by mass of ion-exchanged water was added thereto to stop the aging treatment (shell formation), and then cooled to 30° C. under a condition of 8° C./min, the particles thus formed was filtered, then repeatedly washed with ion-exchanged water at 45° C., and dried using hot air at 40° C., thereby obtaining toner base particles (1) having a constitution obtained by forming a shell on the surface of the core particles.

(5-4) External Addition Treatment (Addition of Metal-Containing Compound)

An external additive including 7 parts by mass of the metal-containing compound particles (1), 0.6 parts by mass of hexamethylsilazane treated silica (average primary particle size of 12 nm), and 0.8 parts by mass of n-octyl silane treated titania (average primary particle size of 24 nm) was added to the toner base particles (1) thus obtained, and the resultant was mixed using a Henschel mixer (manufactured by MITSUI MIKE MACHINERY Co., Ltd.) under the conditions of a stirring blade peripheral speed of 35 m/s, a treatment temperature of 35° C., and a treatment time of 15 minutes, thereby performing the external addition treatment to obtain a magenta toner (1).

Meanwhile, the shape and particle size of the toner particles did not change by the addition of the external additive.

### Examples 2 to 17

Magenta toners (2) to (17) were obtained in the same manner as in Example 1 except that the colorant compound precursor and the metal-containing compound were changed to the compounds shown in Table 2, respectively.

### Comparative Example 1

### (1) Preparation of Colorant Compound Precursor Dispersion

A comparative colorant compound precursor dispersion (1) was obtained by the same method as the preparation method of the colorant compound precursor dispersion in Example 1 above. The volume-based median diameter was measured with respect to the particle size of the particles of the colorant compound precursor in this comparative colorant compound precursor dispersion (1) under the same measurement conditions as in Example 1, and the result was 221 nm.

### (2) Preparation of Metal-Containing Compound Dispersion

A comparative metal-containing compound dispersion (1) was prepared by performing the operation to the stage before the formation of the wet cake of the metal-containing compound particles in the preparation of the metal-containing compound particles in Example 1 above.

In other words, a metal-containing compound dispersion (hereinafter, referred to as the “comparative metal-containing compound dispersion (1)”) having particles of the metal-containing compound dispersed therein was prepared by the same method as the preparation method of the colorant compound precursor dispersion in Example 1 above except using 19.4 parts by mass of the metal coordination compound represented by Formula (3-4) as the metal-containing compound instead of the compound (colorant compound precursor) represented by Formula (1-16).

The volume-based median diameter was measured with respect to the particle size of the particles of the metal-containing compound in the comparative metal-containing compound dispersion (1) under the same measurement conditions as in Example 1 above, and the result was 121 nm.

### (3) Preparation of Resin Particle for Core Particle

Comparative resin particles for core particles (1) were obtained by the same method as the preparation method of the resin particles for core particles in Example 1 above.

The weight average molecular weight of the comparative resin particles for core particles (1) thus obtained was 26,800. In addition, the glass transition temperature (Tg) thereof was 50° C.

### (4) Preparation of Resin Particle for Shell

Comparative resin particles for shell (1) were obtained by the same method as the preparation method of the resin particles for shell in Example 1 above.

The weight average molecular weight of the comparative resin particles for shell (1) thus obtained was 42,500. In addition, the glass transition temperature (Tg) thereof was 60° C.

### (5) Preparation of Toner Particle

(5-1) Formation of Core Particle

Into the reaction vessel equipped with a stirrer, a temperature sensor, a cooling pipe, and a nitrogen gas introducing device, 420.7 parts by mass of the comparative resin particles for core particles (1), 900 parts by mass of ion-exchanged water, and 42 parts by mass (7 parts by mass in terms of solid content) of the comparative colorant compound precursor dispersion (1) were introduced and stirred, and the internal temperature thereof was adjusted so as to be 30° C., thereafter an aqueous sodium hydroxide solution having a concentration of 5 mol/liter was added thereto to adjust the pH to 9.

Subsequently, an aqueous solution prepared by dissolving 2 parts by mass of magnesium chloride hexahydrate in 1000 parts by mass of ion-exchanged water was added over 10 minutes at 30° C. while stirring. The temperature rising of the mixture was started after leaving to stand for 3 minutes, and the temperature of this system was raised to 65° C. over 60 minutes.

In this state, 42 parts by mass (7 parts by mass in terms of solid content) of the comparative metal-containing compound dispersion (1) was further added thereto and followed by stirring.

Thereafter, the average particle size of the associated particles was measured by the “Coulter Multisizer 3” (manufactured by Beckman Coulter, Inc.), and an aqueous solution prepared by dissolving 40.2 parts by mass of sodium chloride in 1000 parts by mass of ion-exchanged water was added to the system when the volume-based median diameter became 6.5 μm to stop the particle growth. The system was further heated and stirred for 1 hour at a liquid temperature of 70° C. to continue the fusion, thereby obtaining a comparative core particle-containing liquid (1) containing the comparative core particles (1). At this time, it was confirmed that the colorant compound was produced by the reaction of the colorant compound precursor with the metal-containing compound from the absorption spectrum of the solution.

The average circularity was measured with respect to the comparative core particles (1) thus obtained using the “FPIA2100” (manufactured by Sysmex Corporation), and the result was 0.912.

(5-2) Formation of Shell Part

A shell part was formed on the surface of the core particles in the same manner as the “(5-2) formation of shell part” in Example 1 above.

(5-3) Cooling, Filtering, and Drying

Comparative toner base particles (1) having a constitution obtained by forming a shell on the surface of the core particles were obtained by performing the same treatment as the “(5-3) Cooling, filtering, and drying” in Example 1 above.

(5-4) External Addition Treatment

A comparative magenta toner (1) was obtained in the same manner as in Example 1 above except that the metal-containing compound particles (1) were not added in the “(5-4) external addition treatment” in Example 1 above.

Meanwhile, the shape and particle size of the toner particles did not change even when the external additive was added.

### Comparative Examples 2 to 6

Comparative magenta toners (2) to (6) were obtained in the same manner as in Comparative Example 1 except that the colorant compound precursor and the metal-containing compound were changed to the compounds shown in Table 2, respectively.

<<Evaluation of Toner>>

The following evaluations were performed with respect to the toner obtained in Examples and Comparative Examples. The results of the evaluations are shown in Table 2.

(1) Evaluation of Fluidity

The bulk density was obtained by a Kawakita-type bulk density meter (IH2000 model) as an indicator of fluidity. Specific measurement method of the bulk density is as follows.

The toner before being subjected to the image evaluation was placed on a 120 mesh sieve, dropped for 90 seconds at a oscillation strength of 6, and then the oscillation was stopped and left to stand for 30 seconds, thereafter, the level bulk density (toner weight/volume) was obtained.

It indicates that the fluidity is more favorable as (bulk density)/(true density) is greater, and thus the handling ability and the transfer properties become favorable even in the copying machine. The evaluation criteria are shown below.

(Evaluation Criteria)

0.370 or more: favorable

More than 0.340 and less than 0.370: practically acceptable

0.340 or less: practically unacceptable (transfer failure occurs at a high temperature and a high humidity).

(2) Evaluation of Storage Stability

Into a 10 ml glass bottle with an inner diameter of 21 mm, 0.5 g of toner was introduced and sealed with a lid. The bottle was shaken 600 times at room temperature by the Tap Denser KYT-2000 (manufactured by SEISHIN ENTERPRISE Co., Ltd.), and then left to stand for 2 hours under an environment of 55° C. and 35% RH in the state that the lid was taken off. Subsequently, the toner was placed on a 48 mesh sieve (mesh opening of 350 μm) while paying attention so as not to crush the aggregates of toner, and the sieve was set to a powder tester (manufactured by Hosokawa Micron Ltd.) and fixed by a holding bar and a knob nut. The oscillation strength was adjusted so as to have a feed width of 1 mm, the oscillation was applied for 10 seconds, and then the ratio (% by mass) of the amount of the toner remaining on the sieve was measured.

The aggregation rate of toner is a value calculated by the following equation.

(Aggregation rate of toner (%))=(mass of toner remaining on sieve (g))/0.5 (g)×100

The heat resistant storage stability of toner was evaluated according to the criteria described below. The evaluation criteria are shown below.

(Evaluation Criteria)

Less than 15% by mass of toner aggregation rate: heat resistant storage stability of toner is significantly favorable

15% by mass or more and 20% by mass or less of toner aggregation rate: heat resistant storage stability of toner is favorable

More than 20% by mass of toner aggregation rate: heat resistant storage stability of toner is poor and thus unusable.

(3) Evaluation of Image Density Unevenness

A document on which a solid image having a document reflection density of 1.30 was set at total five locations of the four corners and the center of the image was copied, and the relative reflection density of the output image with respect to the blank was measured at the five locations. Meanwhile, a reflective densitometer RD-917 (manufactured by Macbeth Corporation) was used for the measurement of density. The difference between the maximum value and the minimum value of the image reflection density at the five locations measured by the method described above was taken as the density unevenness. In addition, the evaluation was performed when the copying was completed. The evaluation criteria are shown below.

(Evaluation Criteria)

Less than 0.05 of difference in density: image unevenness is significantly favorable

0.05 or more and less than 0.1 of difference in density: image unevenness is favorable and thus it is a level having no problem.

0.1 or more of difference in density: image unevenness is poor and thus it is a level having a practical problem.

(4) Evaluation of Saturation

A solid image was formed on the “POD 128 g gloss coat (128 g/m²)” (manufactured by Oji Paper Co., Ltd.) in an environment of normal temperature and normal humidity (a temperature of 20° C. and a humidity of 50% RH) using a commercially available multifunction printer “bishub PRO C6501” (manufactured by Konica Minolta Business Technologies, Inc.) as an image forming apparatus by setting the amount of toner on the transfer paper to 4 g/m² and the surface temperature of the heating member of a fixing device according to the heat roller fixing method to 150° C. The saturation of the image thus obtained was measured. The saturation of the image produced on the paper was measured using Macbeth color eye 7000 at a light source of ASTM-D65 with 2 degree visual field and then the evaluation was performed. The evaluation criteria are shown below.

(Evaluation Criteria)

80 or more of value of saturation: the reaction of the colorant compound precursor with the metal-containing compound is significantly favorable

75 or more and less than 80 of value of saturation: the reaction of the colorant compound precursor with the metal-containing compound is favorable

Less than 75 of value of saturation: the reaction of the colorant compound precursor with the metal-containing compound is poor.

Meanwhile, in the evaluation of saturation, the indication “-” in Table 2 indicates that measurement was not performed.

(5) Softening Point Temperature

The softening point temperature of the toner obtained was measured by the method described above.

TABLE 2

| | | | | Evaluation | | | | |
|---|---|---|---|---|---|---|---|---|
| | Form | | | | | | | Softening |
| | of | Material | | | | | | point |
| | metal- | Colorant | Metal- | | | Image | | temperature |
| | containing | compound | containing | | Storage | density | | of |
| | compound | precursor | compound | Fluidity | stability | unevenness | Saturation | toner |
| Example 1 | Added | 1-16 | 3-4 | 0.372 | 4.5% | 0.04 | 76.2 | 113 |
| Example 2 | with | 1-3 | 3-8 | 0.368 | 3.5% | 0.04 | 75.3 | 113 |
| Example 3 | external | 1-4 | 3-12 | 0.375 | 18.2% | 0.04 | — | 113 |
| Example 4 | additive | 1-7 | 3-11 | 0.380 | 10.2% | 0.03 | — | 113 |
| Example 5 | | 1-8 | 3-14 | 0.373 | 12.2% | 0.04 | — | 113 |
| Example 6 | | 1-11 | 3-10 | 0.393 | 7.5% | 0.02 | — | 113 |
| Example 7 | | 1-13 | 3-1 | 0.386 | 6.7% | 0.03 | — | 113 |
| Example 8 | | 1-15 | 3-2 | 0.356 | 13.4% | 0.05 | — | 113 |
| Example 9 | | 1-17 | 3-13 | 0.376 | 17.5% | 0.03 | — | 113 |
| Example 10 | | 1-20 | 3-6 | 0.375 | 9.7% | 0.03 | — | 113 |
| Example 11 | | 1-2 | 3-9 | 0.372 | 19.5% | 0.03 | — | 113 |
| Example 12 | | 1-6 | 3-14 | 0.390 | 6.5% | 0.01 | — | 113 |
| Example 13 | | 1-10 | 3-3 | 0.387 | 5.7% | 0.01 | — | 113 |
| Example 14 | | 1-14 | 3-11 | 0.355 | 13.2% | 0.05 | — | 113 |
| Example 15 | | 1-16 | 3-12 | 0.376 | 15.3% | 0.03 | — | 113 |
| Example 16 | | 2-3 | 3-13 | 0.343 | 7.7% | 0.06 | — | 113 |
| Example 17 | | 2-5 | 3-14 | 0.348 | 6.8% | 0.06 | — | 113 |
| Comparative | Present | 1-16 | 3-4 | 0.335 | 35.0% | 0.16 | 76.2 | 104 |
| Example 1 | in toner | | | | | | | |
| Comparative | as | 1-3 | 3-8 | 0.330 | 30.1% | 0.14 | 75.3 | 104 |
| Example 2 | colorant | | | | | | | |
| Comparative | compound | 1-4 | 3-12 | 0.338 | 41.2% | 0.15 | — | 104 |
| Example 3 | | | | | | | | |
| Comparative | | 1-7 | 3-11 | 0.340 | 38.5% | 0.11 | — | 104 |
| Example 4 | | | | | | | | |
| Comparative | | 1-8 | 3-14 | 0.336 | 40.1% | 0.14 | — | 104 |
| Example 5 | | | | | | | | |
| Comparative | | 1-11 | 3-10 | 0.343 | 37.5% | 0.1 | — | 104 |
| Example 6 | | | | | | | | |

From Table 2, it is indicated that the storage stability of the toner of the present invention is significantly improved. In addition, it is confirmed that the toner of the present invention is also excellent in fluidity. In addition, it is confirmed that the toner of the present invention has a slightly higher softening point temperature compared with the toner of Comparative Examples. It is believed that this is because the plasticization of the resin takes place in the toner of Comparative Examples by the reaction of the metal-containing compound with the colorant compound precursor. Moreover, according to the image forming method using the toner of the present invention, it is also indicated that the image density unevenness is suppressed. Meanwhile, Comparative Examples 1 and 2 corresponding to the related art exhibit a favorable value of saturation but insufficient fluidity and storage stability of toner, and moreover exhibit relatively significant image density unevenness. On the other hand, it can be said that it is indicated that the fluidity and storage stability of toner can be improved and the image density unevenness at the time of forming an image can be reduced while the value of saturation is maintained at the equivalent value in the toner of Examples 1 and 2 of the present invention using the same combination of the colorant compound precursor and the metal-containing compound as Comparative Examples 1 and 2, respectively.

In addition, it is verified that Examples 6 and 13 are favorable even among Examples above, and the combination of the colorant compound precursor (1-11) and the metal-containing compound (3-10) and the combination of the colorant compound precursor (1-10) and the metal-containing compound (3-3) are particularly favorable.

### REFERENCE SIGNS LIST

3 Image forming apparatus
30 (30Y, 30M, 30C, and 30Bk) Image forming unit
31 (31Y, 31M, 31C, and 31Bk) Photoreceptor
32 (32Y, 32M, 32C, and 32Bk) Electrification means
33 (33Y, 33M, 33C, and 33Bk) Exposure means
34 (34Y, 34M, 34C, and 34Bk) Developing means
35 (35Y, 35M, 35C, and 35Bk) Primary transfer roller
36 (36Y, 36M, 36C, and 36Bk) Cleaning means
36A Cleaning means
37 Endless belt-shaped intermediate transfer body unit
41 Fed paper conveying means
42 (42A, 42B, 42C, and 42D) Intermediate roller
43 Resist roller
45 Paper delivery roller
45A Secondary transfer roller
46 Paper delivery tray
50 Fixing device
370 Intermediate transfer body
371,372,373,374, and 376 Roller
A Body
P Recording member
SC Image reading device

What is claimed is:

1. Toner for electrostatic charge image development comprising:
a resin;
a metal-containing compound; and
a colorant compound precursor to be converted to a colorant compound through a reaction with the metal-containing compound by heat applied at heat fixing.

2. The toner for electrostatic charge image development according to claim 1, wherein the colorant compound precursor is a compound represented by General formula (1) or (2), and the metal-containing compound is a compound represented by General formula (3): 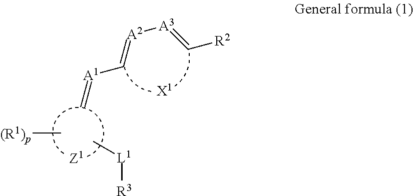
[wherein, R¹ each independently represent a hydrogen atom, a halogen atom or a monovalent organic group, R² represents a —NR⁴R⁵ group (R⁴ and R⁵ each independently represent a hydrogen atom, a halogen atom or a monovalent organic group) or a —OR⁶ group (R⁶ represents a hydrogen atom, a halogen atom or a monovalent organic group), R³ represents a hydroxyl group, an alkoxy group, an aryloxy group, an amino group, an amide group, an alkylsulfonylamino group or an arylsulfonylamino group, A¹ to A³ each independently represent a —CR⁷═ group (R⁷ each independently represent a hydrogen atom, a halogen atom or a monovalent organic group), or a —N═ group, X¹ represents an atomic group necessary to form a 5- or 6-membered aromatic or heterocyclic ring, and Z¹ represents an atomic group necessary to form a 5- or 6-membered heterocyclic ring containing at least one nitrogen atom and this atomic group is optionally unsubstituted or optionally has a substituent, or optionally form a condensed ring with the substituent, L¹ represents a linking group having 1 or 2 carbon atoms or a part of a ring structure, and is optionally bonded to R³ to form a 5- or 6-membered ring structure, p represents an integer of 0 to 3] 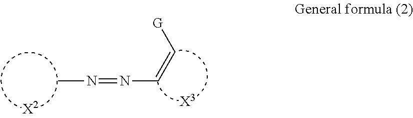
[wherein, X² represents an atomic group necessary to form an aromatic carbocyclic or heterocyclic ring wherein at least one ring is composed of 5 to 7 atoms, and the atomic group necessary to form the heterocyclic ring has a carbon atom bonded to an azo bond and at least one of adjacent positions of the carbon atom is a nitrogen atom or has a structure wherein a carbon atom in the carbocyclic ring is substituted with a nitrogen atom, an oxygen atom or a sulfur atom; X³ represents an atomic group necessary to form an aromatic carbocyclic or heterocyclic ring wherein at least one ring is composed of 5 to 7 atoms, and G represents a hydroxyl group, an amino group, a methoxy group, a thiol group or a thioalkoxy group] 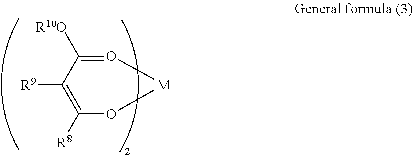
[wherein, M represents a divalent metal atom, R⁸ represents a hydrogen atom or a monovalent organic group, R⁹ represents a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group or a cyano group, and R¹⁰ represents a hydrogen atom, an alkyl group, an alkenyl group, an alkynyl group, an aryl group, an arylalkyl group or a heterocyclic group].

3. The toner for electrostatic charge image development according to claim 2, wherein the colorant compound precursor is a compound represented by General formula (1).

4. The toner for electrostatic charge image development according to claim 1, wherein the toner for electrostatic charge image development contains a toner base particle including the resin, the colorant compound precursor is contained in the toner base particle, and the metal-containing compound is dispersed on a surface of the toner base particle.

5. The toner for electrostatic charge image development according to claim 1, wherein the toner for electrostatic charge image development contains a toner base particle having core-shell structure including the resin, the colorant compound precursor is contained in the core part of the core-shell structure, and the metal-containing compound is dispersed on a surface of the toner base particle.

6. A method of manufacturing a toner for electrostatic charge image development comprising a step of mixing a resin, a metal-containing compound, and a colorant compound precursor to be converted to a colorant compound through a reaction with the metal-containing compound by heat applied at heat fixing.

7. An image forming method comprising a step of heat fixing a toner image formed by the toner for electrostatic charge image development according to claim 1 and producing a colorant compound by reacting the colorant compound precursor with the metal-containing compound.
